(19) United States
(12) Patent Application Publication
(10) Pub. No.: US 2026/0303227 A1
(43) Pub. Date: Oct. 1, 2026

(54) SYSTEM AND METHOD FOR CALIBRATION USING LOCAL OSCILLATOR (LO) PHASE SHIFT

(71) Applicant: QUALCOMM INCORPORATED, SAN DIEGO, CA (US)

(72) Inventors: Ojas CHOKSI, San Diego, CA (US); Ghaith SHABSIGH, San Diego, CA (US)

(21) Appl. No.: 19/091,976

(22) Filed: Mar. 27, 2025

(51) Int. Cl. H04B 17/11; H04B 1/04; H04B 17/21

(52) U.S. Cl. CPC H04B 17/11; H04B 1/0475; H04B 17/21

(57) ABSTRACT

A residual sideband (RSB) calibration system includes a phase locked loop (PLL) circuit shared between a transmit (Tx) circuit and a receive (Rx) circuit, the PLL circuit configured to provide a local oscillator (LO) signal to transmit mixers in the Tx circuit and to receive mixers in the Rx circuit, a phase shifter connected between an output of the PLL circuit and the receive mixers, and a loopback circuit connecting the Tx circuit and the Rx circuit.

### FIELD

The present disclosure relates generally to electronics, and more specifically to frequency dependent residual sideband (FDRSB) calibration in a transceiver.

### BACKGROUND

Wireless communication devices and technologies are becoming ever more prevalent, as are communication devices that operate at millimeter-wave (mmW) and sub-terahertz (subTHz) frequencies. Wireless communication devices generally transmit and/or receive communication signals. In a radio frequency (RF) transceiver, a communication signal is typically amplified and transmitted by a transmit section and a received communication signal is amplified and processed by a receive section. A transceiver for communication in 5G and 6G applications realizing very high throughput may communicate using millimeter wave (mmW) frequency signals and sub-THz frequencies using ultra wide signal bandwidths. Higher modulation schemes such as quadrature amplitude modulation (QAM) may be used for such transceivers to achieve high spectral efficiency while relaxing analog-to-digital converter (ADC) and digital-to-analog converter (DAC) sampling rates. However, the peak throughput or signal-to-noise ratio (SNR) is often limited by a phenomenon referred to as residual sideband (RSB). RSB corresponds to in-phase (I) quadrature (Q) signal imbalance caused by various circuit or layout imperfections, mismatches, etc., and is expressed in dB as the ratio of the signal tone to its image tone. RSB can be frequency independent RSB (FIDRSB) or frequency dependent RSB (FDRSB). FIDRSB generally refers to in-phase (I) and quadrature (Q) signal paths and it is independent of signal bandwidth. FIDRSB is mainly caused by gain/phase imbalances in the upconverter/downconverter mixers. FDRSB generally refers to mismatches between the in-phase (I) and quadrature (Q) signal paths and can be dependent on the signal bandwidth. Therefore, it is desirable to calibrate a communication system to minimize FDRSB.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a residual sideband (RSB) calibration system including a phase locked loop (PLL) circuit shared between a transmit (Tx) circuit and a receive (Rx) circuit, the PLL circuit configured to provide a local oscillator (LO) signal to transmit mixers in the Tx circuit and to receive mixers in the Rx circuit, a phase shifter connected between an output of the PLL circuit and the receive mixers, and a loopback circuit connecting the Tx circuit and the Rx circuit.

Another aspect of the disclosure provides a method for joint transmit and receive residual sideband (RSB) calibration including injecting a transmit (Tx) signal at a first phase of a local oscillator (LO) into a receive (Rx) circuit via a loopback circuit; measuring a main signal tone and an image signal tone at the first LO phase; shifting the first LO phase signal by 90 degrees to a second LO phase; injecting the Tx signal into the Rx circuit via the loopback circuit; measuring a main signal tone and an image signal tone at the second LO phase; determining a ratio of the image signal tone to the main signal tone at the first LO phase and the second LO phase to obtain a Tx RSB and a Rx RSB; adjusting a filter to compensate for the Tx RSB; and compensating for the Rx RSB by pre-distorting an Rx signal.

Another aspect of the disclosure provides a method for joint transmit and receive residual sideband (RSB) calibration including generating a local oscillator (LO) signal in a phase locked loop (PLL) circuit, the PLL circuit shared between a transmit (Tx) circuit and a receive (Rx) circuit, the PLL circuit configured to provide the local oscillator (LO) signal to transmit mixers in the Tx circuit and to receive mixers in the Rx circuit; connecting a loopback circuit between the Tx circuit and the Rx circuit, the loopback circuit for injecting a transmit (Tx) signal at a first phase into a receive (Rx) circuit and for injecting the transmit (Tx) signal at a second phase into a receive (Rx) circuit; and generating the second phase by shifting the LO signal with a phase shifter between an output of the PLL circuit and the receive mixers.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a diagram showing a wireless device communicating with a wireless communication system.

FIG. 2A is a block diagram showing a wireless device in which exemplary techniques of the present disclosure may be implemented

FIG. 2B is a block diagram showing a wireless device in which exemplary techniques of the present disclosure may be implemented.

FIG. 2C is a block diagram showing a wireless device in which exemplary techniques of the present disclosure may be implemented.

FIG. 3 is a block diagram of a portion of an intermediate frequency (IF) transceiver in accordance with an exemplary embodiment of the disclosure.

FIGS. 4A and 4B are a diagram of an exemplary embodiment of a phase shifter of FIG. 3.

FIGS. 5A and 5B are a diagram of an alternative exemplary embodiment of a phase shifter of FIG. 3.

FIG. 6 is a series of graphs showing Tx and Rx RSB measurement with no LO phase shift.

FIG. 7 is a series of graphs showing Tx and Rx RSB measurement with a +90 degree LO phase shift.

FIG. 8 is a flow chart describing an example of the operation of a method for RSB calibration.

FIG. 9 is a functional block diagram of an apparatus for RSB calibration.

### DETAILED DESCRIPTION

The word “exemplary” is used herein to mean “serving as an example, instance, or illustration.” Any aspect described herein as “exemplary” is not necessarily to be construed as preferred or advantageous over other aspects.

FDRSB is mainly caused by gain/phase mismatches over frequency in a baseband filter and timing skews in the ADC/DAC. FDRSB generally degrades with wider signal bandwidth and it is very challenging to achieve a high value when the fractional bandwidth of the signal to its carrier frequency is high. FDRSB due to low pass filtering and the operation of the DAC in the transmit path degrades error vector magnitude (EVM) while FDRSB in the receive path occurring due to low pass filtering and operation of the ADC degrades the overall SNR.

Transceivers used in some 5G communication systems generally use what is referred to as time domain duplexing (TDD), where transmission and reception of signals is separated into different time slots. Some TDD transceivers can have a single phase locked loop (PLL) shared between Rx and Tx chains. Since the Rx/Tx signal chains are not ON at the same time, they can share the same local oscillator (LO) frequency. Sharing a single PLL is desirable because it reduces circuit die area. In a TDD system, a single LO frequency is used for both Tx and Rx circuits. As a result, the FDRSB components of Tx and Rx overlap in the same frequency bin.

In order to distinguish between Tx and Rx FDRSB components for estimation and correction, certain joint estimation calibration techniques rely on a loopback method with a phase shifter located in the signal path between the Tx and Rx ports. The technique uses a positive and negative frequency domain multi-tone training signal centered around the local oscillator (LO) frequency with the spacings between the tones carefully selected such that the image tones as well as intermodulation nonlinearities (IM2, IM3, IM5 etc.) don't overlap with the main tones. Two measurements are done, one with the loopback path phase shifter bypassed and the other with the phase shifter not bypassed and having a known phase shift. In each measurement, the received power of the main tones and the image tones are measured. Since the phase shift in the second measurement is known, it can be shown that the Tx FDRSB and the Rx FDRSB components occupying the same frequency bin have opposite phase shifts. Thus, both Tx and Rx FDRSB estimation can be done based on the measured main tones, image tones, and the known phase shift in each measurement through a simple matrix calculation. Further, it can be shown that the mean square error (MSE) for Tx/Rx FDRSB estimation is inversely proportional to the receive SNR and is a strong function of the phase shifter frequency response. For minimal MSE, a 90 degree phase shift over a large signal bandwidth and at least 5 dB of gain in the phase shifter is desired.

FDRSB calibration of the receive (Rx) chain may use a transmit (Tx) tone, whether injected to the Rx chain from an external port or injected internally, through a loopback circuit architecture with a 90 degree phase shifter. Internal Tx tone loopback is desirable since it eliminates an external connection. A quarter-wave transmission line phase shifter can achieve 90 degree phase shift over a wide signal bandwidth. However a quarter-wave transmission line phase shifter occupies a very large area for on-die integration and it is very lossy. A multi-section wide bandwidth lumped element alternative for the λ/4 transmission line phase shifter is also very area intensive and lossy. Further, a very high isolation is desired between the Tx and the Rx ports such that the phase shifter is not bypassed. This imposes challenging floorplan/area requirements on the placement of Tx/Rx blocks in terms of block separation, loopback routing and generally leads to the use of high isolation switches which are very lossy.

In accordance with an exemplary embodiment, a system and method for RSB calibration in a time domain duplexing (TDD) communication system uses a phase shift in an LO path instead of in a signal path to measure and compensate for FDRSB.

In accordance with an exemplary embodiment, the system and method for RSB calibration in a time domain duplexing (TDD) communication system imparts a phase shift in the LO path to eliminate the challenges of applying the phase shift in a signal path.

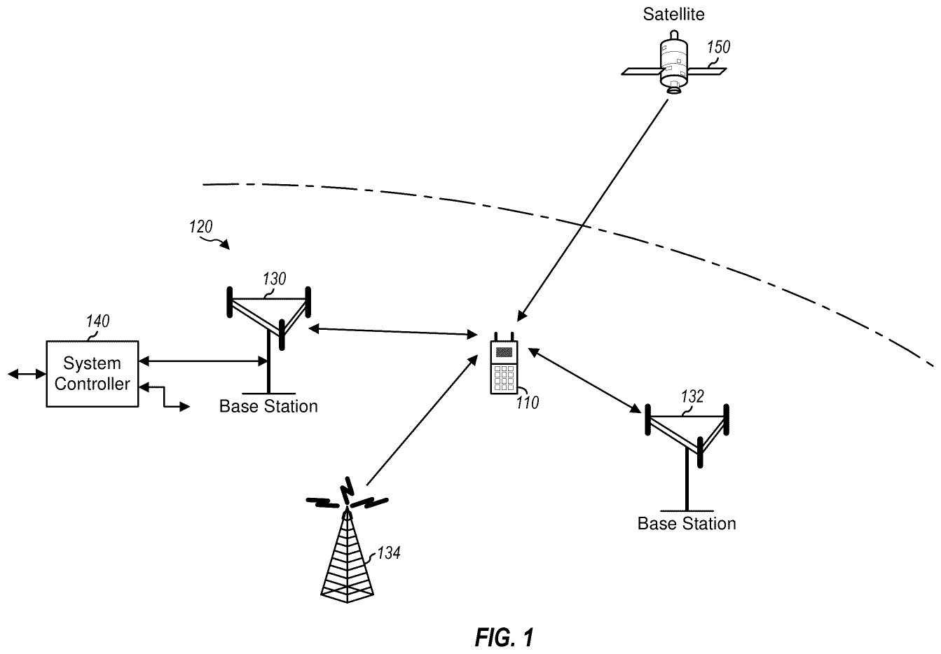

FIG. 1 is a diagram showing a wireless device 110 communicating with a wireless communication system 120. The wireless communication system 120 may be a Long Term Evolution (LTE) system, a Code Division Multiple Access (CDMA) system, a Global System for Mobile Communications (GSM) system, a wireless local area network (WLAN) system, a 5G NR (new radio) system, or some other wireless system. A CDMA system may implement Wideband CDMA (WCDMA), CDMA 1×, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless communication system may include any number of base stations and any set of network entities.

The wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a tablet, a cordless phone, a medical device, an automobile, a device configured to connect to one or more other devices (for example through the internet of things), a wireless local loop (WLL) station, a Bluetooth device, etc. Wireless device 110 may communicate with wireless communication system 120. Wireless device 110 may also receive signals from broadcast stations (e.g., a broadcast station 134) and/or signals from satellites (e.g., a satellite 150 in one or more global navigation satellite systems (GNSS)), etc). Wireless device 110 may support one or more radio technologies for wireless communication such as LTE, WCDMA, CDMA 1×, EVDO, TD-SCDMA, GSM, 802.11, 802.15, 5G-NR, FMCW, 6G, UWB, etc., for FR1, 5G FR2, FR2-2, FR3, and D-band frequencies.

Wireless device 110 may support carrier aggregation, for example as described in one or more LTE or 5G standards. In some embodiments, a single stream of data is transmitted over multiple carriers using carrier aggregation, for example as opposed to separate carriers being used for respective data streams. Wireless device 110 may be able to operate in a variety of communication bands including, for example, those communication bands used by LTE, WiFi, 5G or other communication bands, over a wide range of frequencies. Wireless device 110 may also be capable of communicating directly with other wireless devices without communicating through a network.

In general, carrier aggregation (CA) may be categorized into two types-intra-band CA and inter-band CA. Intra-band CA refers to operation on multiple carriers within the same band. Inter-band CA refers to operation on multiple carriers in different bands.

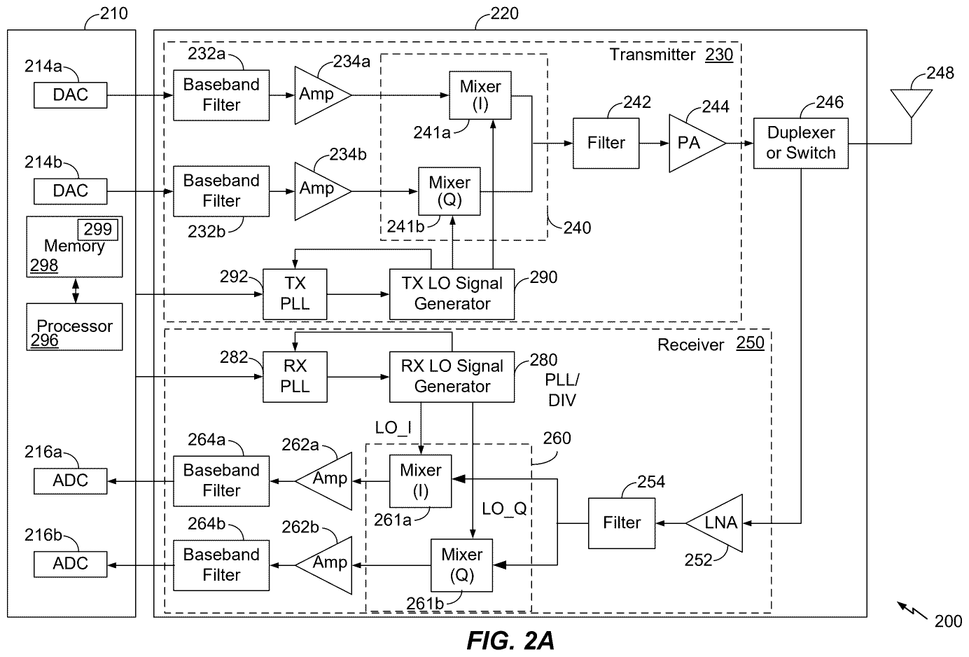

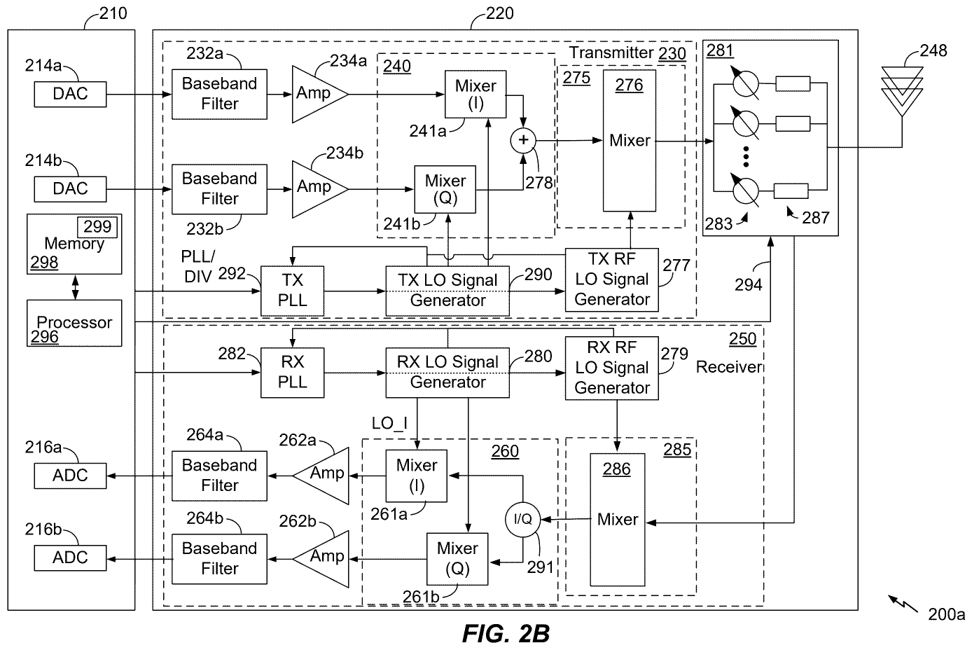

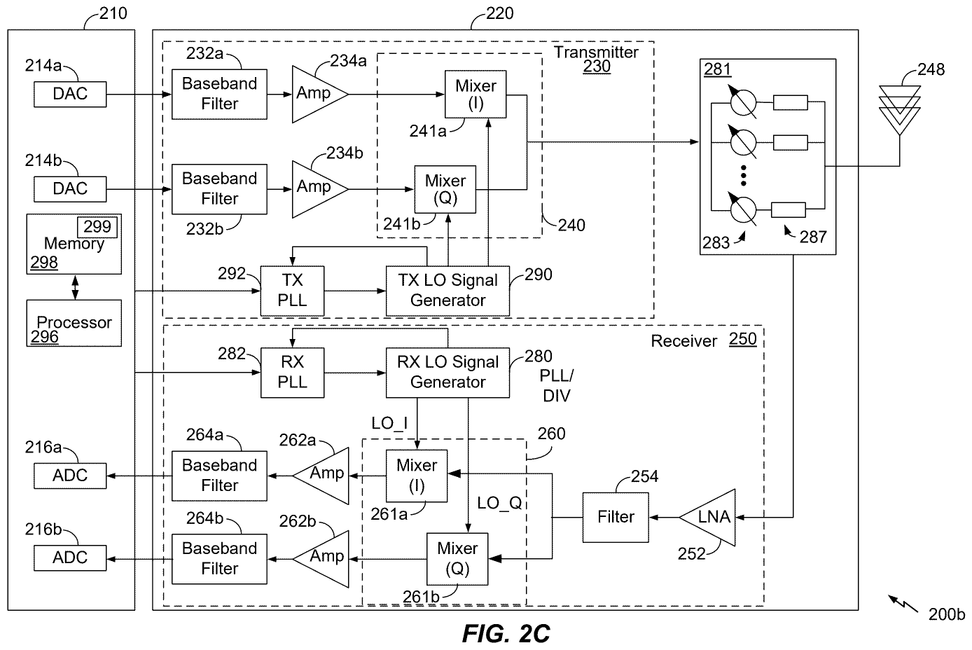

FIG. 2A is a block diagram showing a wireless device 200 in which exemplary techniques of the present disclosure may be implemented. The wireless device 200 may, for example, be an embodiment of the wireless device 110 illustrated in FIG. 1.

FIG. 2A shows an example of a transceiver 220 having a transmitter 230 and a receiver 250. In general, the conditioning of the signals in the transmitter 230 and the receiver 250 may be performed by one or more stages of amplifier, filter, upconverter, downconverter, etc. These circuit blocks may be arranged differently from the configuration shown in FIG. 2A. Furthermore, other circuit blocks not shown in FIG. 2A may also be used to condition the signals in the transmitter 230 and receiver 250. Unless otherwise noted, any signal in FIG. 2A, or any other figure in the drawings, may be either single-ended or differential. Some circuit blocks in FIG. 2A may also be omitted.

In the example shown in FIG. 2A, wireless device 200 generally comprises the transceiver 220 and a data processor 210. The data processor 210 may include a processor 296 operatively coupled to a memory 298. The memory 298 may be configured to store data and program codes shown generally using reference numeral 299 to denote a memory or a memory location, and may generally comprise analog and/or digital processing components. The processor 296 and the memory 298 may cooperate to control, configure, program, or otherwise fully or partially control some or all of the operation of the embodiments of the system and method for RSB calibration described herein.

The transceiver 220 includes a transmitter 230 and a receiver 250 that support bi-directional communication. In general, wireless device 200 may include any number of transmitters and/or receivers for any number of communication systems and frequency bands. All or a portion of the transceiver 220 may be implemented on one or more analog integrated circuits (ICs), RF ICs (RFICs), mixed-signal ICs, etc.

A transmitter or a receiver may be implemented with a super-heterodyne architecture or a direct-conversion architecture. In the super-heterodyne architecture, a signal is frequency-converted between radio frequency (RF) and baseband in multiple stages, e.g., from RF to an intermediate frequency (IF) in one stage, and then from IF to baseband in another stage for a receiver. In the direct-conversion architecture, a signal is frequency converted between RF and baseband in one stage. The super-heterodyne and direct-conversion architectures may use different circuit blocks and/or have different requirements. In the example shown in FIG. 2A, transmitter 230 and receiver 250 are implemented with the direct-conversion architecture.

In the transmit path, the data processor 210 processes data to be transmitted and provides in-phase (I) and quadrature (Q) analog output signals to the transmitter 230. In an exemplary embodiment, the data processor 210 includes digital-to-analog-converters (DAC's) 214a and 214b for converting digital signals generated by the data processor 210 into the I and Q analog output signals, e.g., I and Q output currents, for further processing. In other embodiments, the DACs 214a and 214b are included in the transceiver 220 and the data processor 210 provides data (e.g., for I and Q) to the transceiver 220 digitally.

Within the transmitter 230, baseband (e.g., lowpass) filters 232a and 232b filter the I and Q analog transmit signals, respectively, to remove undesired images caused by the prior digital-to-analog conversion. Amplifiers (Amp) 234a and 234b amplify the signals from baseband filters 232a and 232b, respectively, and provide I and Q baseband signals. An upconverter 240 having upconversion mixers 241a and 241b upconverts the I and Q baseband signals with I and Q transmit (TX) local oscillator (LO) signals from a TX LO signal generator 290 and provides an upconverted signal. A filter 242 filters the upconverted signal to remove undesired images caused by the frequency upconversion as well as noise in a receive frequency band. A power amplifier (PA) 244 amplifies the signal from filter 242 to obtain the desired output power level and provides a transmit RF signal. The transmit RF signal may be routed through a duplexer or switch 246 and transmitted via an antenna 248. While examples discussed herein utilize I and Q signals, those of skill in the art will understand that components of the transceiver may be configured to utilize polar modulation.

In the receive path, antenna 248 receives communication signals and provides a received RF signal, which may be routed through duplexer or switch 246 and provided to a low noise amplifier (LNA) 252. The duplexer 246 is designed to operate with a specific RX-to-TX duplexer frequency separation, such that RX signals are isolated from TX signals. The received RF signal is amplified by LNA 252 and filtered by a filter 254 to obtain a desired RF input signal.

Downconversion mixers 261a and 261b in a downconverter 260 mix the output of filter 254 with I and Q receive (RX) LO signals (i.e., LO_I and LO_Q) from an RX LO signal generator 280 to generate I and Q baseband signals. The I and Q baseband signals are amplified by amplifiers 262a and 262b and further filtered by baseband (e.g., lowpass) filters 264a and 264b to obtain I and Q analog input signals, which are provided to data processor 210. In the exemplary embodiment shown, the data processor 210 includes analog-to-digital-converters (ADC's) 216a and 216b for converting the analog input signals into digital signals to be further processed by the data processor 210. In some embodiments, the ADCs 216a and 216b are included in the transceiver 220 and provide data to the data processor 210 digitally.

In FIG. 2A, TX LO signal generator 290 generates the I and Q TX LO signals used for frequency upconversion, while RX LO signal generator 280 generates the I and Q RX LO signals used for frequency downconversion. Each LO signal is a periodic signal with a particular fundamental frequency. A phase locked loop (PLL) 292 receives timing information from data processor 210 and generates a control signal used to adjust the frequency and/or phase of the TX LO signals from LO signal generator 290. Similarly, a PLL 282 receives timing information from data processor 210 and generates a control signal used to adjust the frequency and/or phase of the RX LO signals from LO signal generator 280.

Wireless device 200 may support CA and may (i) receive multiple downlink signals transmitted by one or more cells on multiple downlink carriers at different frequencies and/or (ii) transmit multiple uplink signals to one or more cells on multiple uplink carriers. Those of skill in the art will understand, however, that aspects described herein may be implemented in systems, devices, and/or architectures that do not support carrier aggregation.

Certain components of the transceiver 220 are functionally illustrated in FIG. 2A, and the configuration illustrated therein may or may not be representative of a physical device configuration in certain implementations. For example, as described above, transceiver 220 may be implemented in various integrated circuits (ICs), RF ICs (RFICs), mixed-signal ICs, etc. In some embodiments, the transceiver 220 is implemented on a substrate or board such as a printed circuit board (PCB) having various modules, chips, and/or components. For example, the power amplifier 244, the filter 242, and the duplexer 246 may be implemented in separate modules or as discrete components, while the remaining components illustrated in the transceiver 220 may be implemented in a single transceiver chip.

The power amplifier 244 may comprise one or more stages comprising, for example, driver stages, power amplifier stages, or other components, that can be configured to amplify a communication signal on one or more frequencies, in one or more frequency bands, and at one or more power levels. Depending on various factors, the power amplifier 244 can be configured to operate using one or more driver stages, one or more power amplifier stages, one or more impedance matching networks, and can be configured to provide good linearity, efficiency, or a combination of good linearity and efficiency.

In an exemplary embodiment in a super-heterodyne architecture, the PA 244 and LNA 252 (and filter 242 and filter 254 in some examples) may be implemented separately from other components in the transmitter 230 and receiver 250, for example on a millimeter wave integrated circuit. An example super-heterodyne architecture is illustrated in FIG. 2B.

FIG. 2B is a block diagram showing a wireless device in which exemplary techniques of the present disclosure may be implemented. In an exemplary embodiment, FIG. 2B shows a wireless device that uses a beam forming heterodyne (or superheterodyne) architecture for a phased array time domain duplex (TDD) system.

Certain components, for example which may be indicated by identical reference numerals, of the wireless device 200a in FIG. 2B may be configured similarly to those in the wireless device 200 shown in FIG. 2A and the description of identically numbered items in FIG. 2B will not be repeated.

The wireless device 200a is an example of a heterodyne (or superheterodyne) architecture in which the upconverter 240 and the downconverter 260 are configured to process a communication signal between baseband and an intermediate frequency (IF). The IF signal may be a low IF (LIF) signal, or a zero (or near zero) IF (ZIF) signal. For example, the upconverter 240 may include a summing function 278 and may be configured to provide an IF signal to an upconverter 275. In an exemplary embodiment, the upconverter 275 may comprise upconversion mixer 276. The summing function 278 combines the I and the Q outputs of the upconverter 240 and provides a non-quadrature signal to the mixer 276. The non-quadrature signal may be single ended or differential. The mixer 276 is configured to receive the IF signal from the upconverter 240 and TX RF LO signals from a TX RF LO signal generator 277, and provide an upconverted RF signal to phase shift circuitry 281. While PLL 292 is illustrated in FIG. 2B as being shared by the signal generators 290, 277, a respective PLL for each signal generator may be implemented.

In an exemplary embodiment, components in the phase shift circuitry 281 may comprise one or more adjustable or variable phased array elements, and may receive one or more control signals from the data processor 210 over connection 294 and operate the adjustable or variable phased array elements based on the received control signals.

In an exemplary embodiment, the phase shift circuitry 281 comprises phase shifters 283 and phased array elements 287. Although three phase shifters 283 and three phased array elements 287 are shown for ease of illustration, the phase shift circuitry 281 may comprise more or fewer phase shifters 283 and phased array elements 287.

Each phase shifter 283 may be configured to receive the RF transmit signal from the upconverter 275, alter the phase by an amount, and provide the RF signal to a respective phased array element 287. Each phased array element 287 may comprise transmit and receive circuitry including one or more filters, amplifiers, driver amplifiers, and/or power amplifiers. In some embodiments, the phase shifters 283 may be incorporated within respective phased array elements 287.

The output of the phase shift circuitry 281 is provided to an antenna array 248. In an exemplary embodiment, the antenna array 248 comprises a number of antennas that typically correspond to the number of phase shifters 283 and phased array elements 287, for example such that each antenna element is coupled to a respective phased array element 287. In an exemplary embodiment, the phase shift circuitry 281 and the antenna array 248 may be referred to as a phased array.

In a receive direction, an output of the phase shift circuitry 281 is provided to a downconverter 285. In an exemplary embodiment, the downconverter 285 may comprise a downconversion mixer 286. In an exemplary embodiment, the mixer 286 downconverts the receive RF signal provided by the phase shift circuitry 281 to an IF signal according to RX RF LO signals provided by an RX RF LO signal generator 279. The downconverter 260 includes an I/Q generation function 291. The I/Q generation function 291 receives the IF signal from the mixer 286 and generates I and Q signals for the downconverter 260, which downconverts the IF signals to baseband, as described above. While PLL 282 is illustrated in FIG. 2B as being shared by the signal generators 280, 279, a respective PLL for each signal generator may be implemented.

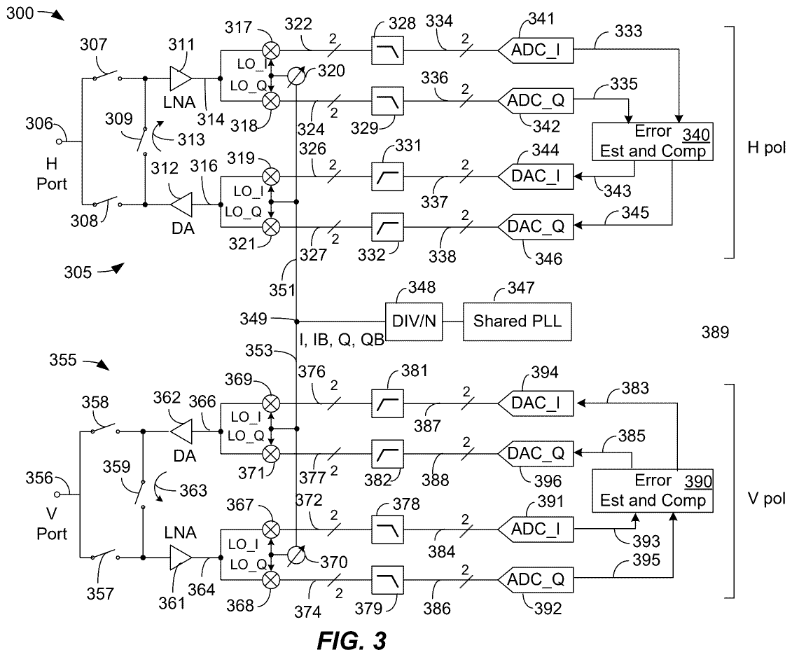

In some embodiments, the upconverter 275, downconverter 285, and the phase shift circuitry 281 are implemented on a common IC. In some embodiments, the summing function 278 and the I/Q generation function 291 are implemented separate from the mixers 276 and 286 such that the mixers 276, 286 and the phase shift circuitry 281 are implemented on the common IC, but the summing function 278 and I/Q generation function 291 are not (e.g., the summing function 278 and I/Q generation function 291 are implemented in another IC coupled to the IC having the mixers 276, 286). The other IC may further include all elements in the transmitter 230 upstream of the summing function 278 and all elements in the receiver 250 downstream of the I/Q generation function 291. In some examples, such other IC may include all elements illustrated and described below with respect to FIG. 3 (potentially with the exception of error estimation and compensation elements 340, 390. In some embodiments, the LO signal generators 277, 279 are included in the common IC. In some embodiments in which phase shift circuitry is implemented on a common IC with 276, 286, 277, 278, 279, and/or 291, the common IC and the antenna array 248 are included in a module, which may be coupled to other components of the transceiver 220 via a connector. In some embodiments, the phase shift circuitry 281, for example, a chip on which the phase shift circuitry 281 is implemented, is coupled to the antenna array 248 by an interconnect or both are mounted to a substrate. For example, components of the antenna array 248 may be implemented on a substrate and coupled to an integrated circuit implementing the phase shift circuitry 281 via a flexible printed circuit or the integrated circuit may be mounted to an opposite side of the substrate. Some configurations described above may be able to be improved in terms of circuit area and/or signal loss, for example as introduced over a cable. Some examples described below may improve upon these aspects and may promote the implementation of relevant circuitry in smaller process nodes.

In some embodiments, both the architecture illustrated in FIG. 2A and the architecture illustrated in FIG. 2B are implemented in the same device. For example, a wireless device 110 or 200 may be configured to communicate with signals having a frequency below about 20 GHz using the architecture illustrated in FIG. 2A and to communicate with signals having a frequency above about 20 GHz using the architecture illustrated in FIG. 2B. In devices in which both architectures are implemented, one or more components of FIGS. 2A and 2B that are identically numbered may be shared between the two architectures. For example, both signals that have been downconverted directly to baseband from RF and signals that have been downconverted from RF to baseband via an IF stage may be filtered by the same baseband filter 264. In other embodiments, a first version of the filter 264 is included in the portion of the device which implements the architecture of FIG. 2A and a second version of the filter 264 is included in the portion of the device which implements the architecture of FIG. 2B. While certain example frequencies are described herein, other implementations are possible. For example, signals having a frequency above about 20 GHz (e.g., having a mmW frequency) may be transmitted and/or received using a direct conversion architecture. In such embodiments, for example, a phased array may be implemented in the direct conversion architecture.

FIG. 2C is a block diagram showing a wireless device in which exemplary techniques of the present disclosure may be implemented. Certain components, for example which may be indicated by identical reference numerals, of the wireless device 200b in FIG. 2C may be configured similarly to those in the wireless device 200 shown in FIG. 2A and/or the wireless device 200a shown in FIG. 2B and the description of identically numbered items in FIG. 2C will not be repeated.

The wireless device 200b in FIG. 2C incorporates the phase shift circuitry 281 (of FIG. 2B) in a direct conversion architecture, where mmW transmission signals are upconverted and downconverted between baseband and RF without the use of intermediate frequency (IF) signal conversion. For example, the LO signals in the architecture of FIG. 2C may comprise signals at frequencies of tens of GHz.

In some embodiments, the upconverter 240, downconverter 260, and the phase shift circuitry 281 are implemented on a common IC. In some embodiments, the LO signal generators 280, 290 are included in the common IC. In some embodiments, the common IC and the antenna array 248 are included in a module, which may be coupled to other components of the transceiver 220 via a connector. In some embodiments, the phase shift circuitry 281, for example, a chip on which the phase shift circuitry 281 is implemented, is coupled to the antenna array 248 by an interconnect or both are mounted to a substrate. For example, components of the antenna array 248 may be implemented on a substrate and coupled to an integrated circuit implementing the phase shift circuitry 281 via a flexible printed circuit or the integrated circuit may be mounted to an opposite side of the substrate.

FIG. 3 is a block diagram of a portion of an intermediate frequency (IF) circuit in accordance with an exemplary embodiment of the disclosure. In an exemplary embodiment, elements in the IF circuit 300 may be examples of circuits and components that may be part of the transmitter 230, receiver 250 and data processor 210 of FIGS. 2A, 2B, 2C. Elements in FIG. 3 that correspond with the elements of FIGS. 2A-2C will be apparent based on the names of those elements. In an exemplary embodiment, the IF circuit 300 may include a horizontal polarization (H-pol) circuit 305 and a vertical polarization (V-pol) circuit 355. In an exemplary embodiment, both the H-pol circuit 305 and the V-pol circuit 355 use the same shared phase locked loop (PLL) circuit 347. The PLL circuit 347 generally includes a voltage controlled oscillator (VCO) (not shown) and additional circuitry (also not shown) to generate local oscillator (LO) signals for signal downconversion and signal upconversion. In the exemplary embodiment shown in FIG. 3, the IF circuit 300 is configured to operate in a time domain duplexing (TDD) architecture where transmit (Tx) and receive (Rx) signals share the same frequencies, but are separated in time. The LO signal output of the PLL circuit 347 may be provided to a divider 348. The divider 348 may be an integer-N divider, where “N” is an integer, or may be a fractional-N divider, where N is a non-integer.

In an exemplary embodiment, the divider 348 may be a div/2 divider configured to provide differential in-phase (I) and quadrature (Q) LO signals I+ (also called I), I− (also called IB), Q+ (also called Q), and Q− (also called QB). The I, IB, Q and QB LO signals are provided to a node 349 and then provided to the H-pol circuit 305 over connection 351 and provided to the V-pol circuit 355 over connection 353.

In an exemplary embodiment, the H-pol circuit 305 may include a port 306 to which an IF signal is applied. The port 306 may be connected to a switch 307 and to a switch 308. The switch 307 is also connected to an input of a low noise amplifier (LNA) 311. The switch 308 is also connected to an output of a driver amplifier (DA) 312. The switch 307 is also connected to one side of a switch 309. The switch 308 is also connected to another side of the switch 309. When the switch 309 is conductive, a loopback path 313 from an output of the driver amplifier 312 to the input of the LNA 311 is created. The loopback path 313 may be used to inject a transmit (Tx) signal from the DA 312 directly into the input of the LNA 311 as will be described below.

In an exemplary embodiment, the H-pol circuit 305 also includes mixers 317 and 318 configured to receive the signal output of the LNA 311 over connection 314. In an exemplary embodiment, the mixer 317 may be configured as an in-phase (I) mixer and the mixer 318 may be configured as a quadrature (Q) mixer. Although single-ended connections are shown for simplicity, the signal path and the LO path can be a combination of single-ended and differential signals or it may be fully differential.

The I mixer 317 may be configured to receive I (I+) and IB (I−) LO signals from the PLL 347; and the Q mixer 318 may be configured to receive Q (Q+) and QB (Q−) LO signals from the PLL 347. The I mixer 317 may be configured to downconvert the signal on connection 314 to a baseband, or near baseband, signal based on the I (I+) and IB (I−) LO signals. Similarly, the Q mixer 318 may be configured to downconvert the signal on connection 314 to a baseband, or near baseband, signal based on the Q (Q+) and QB (Q−) LO signals.

In an exemplary embodiment, an output of the I mixer 317 is provided over connection 322 to a low pass filter 328 and an output of the Q mixer 318 is provided over connection 324 to a low pass filter 329. The low pass filters 328 and 329 can be configured to select the desired signal, reject out-of-band jammers and provide anti-aliasing for the analog-to-digital converters (ADCs). An output of the low pass filter 328 is provided over connection 334 to an analog-to-digital converter (ADC) 341, and an output of the low pass filter 329 is provided over connection 336 to an ADC 342. The ADC 341 digitizes the analog I information signal on connection 334 and provides it to a baseband processing system (such as the data processor 210 of FIGS. 2A, 2B, 2C) for further processing. Similarly, the ADC 342 digitizes the analog Q information signal on connection 336 and provides it to a baseband processing system (such as the data processor 210 of FIGS. 2A, 2B, 2C) for further processing. In an exemplary embodiment, the output of the ADC 341 and ADC 342 may also be provided to an error estimation and compensation element 340 over respective connections 333 and 335. In an exemplary embodiment, the error estimation and compensation element 340 can measure the main tone and the image tone to generate error estimation and compensation signals to perform joint Tx and Rx RSB calibration. In an exemplary embodiment, the error estimation and compensation element 340 may comprise processing circuitry configured to determine the power of a main tone and image tones and may include a complex finite impulse response filter (cFIR) (or in some embodiments, a real FIR) configured to provide FDRSB compensation. In an exemplary embodiment, the error estimation and compensation element 340 may be implemented in digital processing circuitry, such as in the data processor 210 of FIG. 2A, 2B or 2C.

In an exemplary embodiment, a digital-to-analog converter (DAC) 344 may be configured to receive a digital signal from a baseband processor (such as the data processor 210 of FIGS. 2A, 2B, 2C) and provide an analog I information signal on connection 337. Similarly, a DAC 346 may be configured to receive a digital signal from a baseband processor (such as the data processor 210 of FIGS. 2A, 2B, 2C) and provide an analog Q information signal on connection 338. Although single-ended connections are shown for simplicity, the signal path and LO path can be a combination of single-ended and differential signals or it may be fully differential. In an exemplary embodiment, the DAC 344 and the DAC 346 may receive compensation signals over respective connections 343 and 345 from the error estimation and compensation element 340.

The analog I information signal is filtered by a low pass filter 331 and provided over connection 326 to an I mixer 319, and the analog Q information signal is filtered by a low pass filter 332 and provided over connection 327 to a Q mixer 321. The low pass filters 331 and 332 can be configured to filter out any unwanted DAC images.

In an exemplary embodiment, the I mixer 319 is configured to receive I (I+) and IB (I−) LO signals over the connection 351 and upconvert the information signal on connection 326 to an IF signal on connection 316. Similarly, the Q mixer 321 is configured to receive Q (Q+) and QB (Q−) LO signals over the connection 351 and upconvert the information signal on connection 327 to an IF signal on connection 316. The IF signal on connection 316 is provided to the DA 312 for amplification and transmission via the port 306 when the switch 308 is conductive. In an exemplary embodiment, when the switches 307 and 308 are non-conductive, and when the switch 309 is conductive, the Tx signal output from the DA 312 is provided directly to the input of the LNA 311 to perform FDRSB calibration as will be described in further detail herein.

In an exemplary embodiment, the V-pol circuit 355 may include a port 356 to which an IF signal is applied. The port 356 may be connected to a switch 357 and to a switch 358. The switch 357 is also connected to an input of a low noise amplifier (LNA) 361. The switch 358 is also connected to an output of a driver amplifier (DA) 362. The switch 357 is also connected to one side of a switch 359. The switch 358 is also connected to another side of the switch 359. When the switch 359 is conductive, a loopback path 363 from an output of the driver amplifier 362 to the input of the LNA 361 is created. The loopback path 363 may be used to inject a transmit (Tx) signal from the DA 362 directly into the input of the LNA 361 as will be described below.

In an exemplary embodiment, the V-pol circuit 355 also includes mixers 367 and 368 configured to receive the signal output of the LNA 361 over connection 364. In an exemplary embodiment, the mixer 367 may be configured as an in-phase (I) mixer and the mixer 368 may be configured as a quadrature (Q) mixer. The I mixer 367 may be configured to receive I (I+) and IB (I−) LO signals from the PLL 347; and the Q mixer 368 may be configured to receive Q (Q+) and QB (Q−) LO signals from the PLL 347. The I mixer 367 may be configured to downconvert the signal on connection 364 to a baseband, or near baseband, signal based on the I (I+) and IB (I−) LO signals. Similarly, the Q mixer 368 may be configured to downconvert the signal on connection 364 to a baseband, or near baseband, signal based on the Q (Q+) and QB (Q−) LO signals.

In an exemplary embodiment, an output of the I mixer 367 is provided over connection 372 to a low pass filter 378 and an output of the Q mixer 368 is provided over connection 374 to a low pass filter 379. An output of the low pass filter 378 is provided over connection 384 to an ADC 391, and an output of the low pass filter 379 is provided over connection 386 to an ADC 392. The ADC 391 digitizes the analog I information signal on connection 384 and provides it to a baseband processing system (such as the data processor 210 of FIGS. 2A, 2B, 2C) for further processing. Similarly, the ADC 392 digitizes the analog Q information signal on connection 386 and provides it to a baseband processing system (such as the data processor 210 of FIGS. 2A, 2B, 2C) for further processing. In an exemplary embodiment, the output of the ADC 391 and ADC 392 may also be provided to an error estimation and compensation element 390 over respective connections 393 and 395. In an exemplary embodiment, the error estimation and compensation element 390 can measure the main tone and the image tone to generate error estimation and compensation signals to perform joint Tx and Rx RSB calibration during the loopback mode calibration with different phase shifts. In an exemplary embodiment, the error estimation and compensation element 390 may comprise processing circuitry configured to determine the power of a main tone and image tones and may include a complex finite impulse response filter (cFIR) or a real FIR, configured to provide FDRSB compensation. In an exemplary embodiment, the error estimation and compensation element 390 may be implemented in digital processing circuitry, such as in the data processor 210 of FIG. 2A, 2B or 2C.

In an exemplary embodiment, a DAC 394 may be configured to receive a digital signal from a baseband processor (such as the data processor 210 of FIGS. 2A, 2B, 2C) and provide an analog I information signal on connection 387. Similarly, a DAC 396 may be configured to receive a digital signal from a baseband processor (such as the data processor 210 of FIGS. 2A, 2B, 2C) and provide an analog Q information signal on connection 388. Although single-ended connections are shown for simplicity, the signal path and LO path can be a combination of single-ended and differential signals or it may be fully differential. In an exemplary embodiment, the DAC 394 and the DAC 396 may receive compensation signals over respective connections 383 and 385 from the error estimation and compensation element 390.

The analog I information signal is filtered by a low pass filter 381 and provided over connection 376 to an I mixer 369, and the analog Q information signal is filtered by a low pass filter 382 and provided over connection 377 to a Q mixer 371.

In an exemplary embodiment, the I mixer 369 is configured to receive I (I+) and IB (I−) LO signals from the connection 353 and upconvert the information signal on connection 376 to an IF signal on connection 366. Similarly, the Q mixer 371 is configured to receive Q (Q+) and QB (Q−) LO signals from the connection 353 and upconvert the information signal on connection 377 to an IF signal on connection 366. The IF signal on connection 366 is provided to the DA 362 for amplification and transmission via the port 356 when the switch 358 is conductive. In an exemplary embodiment, when the switches 357 and 358 are non-conductive, and when the switch 359 is conductive, the Tx signal output from the DA 362 is provided directly to the input of the LNA 361 to perform FDRSB calibration as will be described in further detail herein.

In an exemplary embodiment, a phase shifter 320 is located in the LO path between connection 351 and the I mixer 317 and Q mixer 318. Similarly, a phase shifter 370 is located in the LO path between connection 353 and the I mixer 367 and Q mixer 368. As will be described below, the phase shifter 320 and the phase shifter 370 may be configured to shift the phase of the LO signal from the PLL 347 by, for example, +90 degrees (or −90 degrees), so that FDRSB calibration can be performed. The phase shifters 320 and 370 may also be configured to impart no (0) phase shift to the LO signals from the PLL 347. In an exemplary embodiment, the phase of the LO signal may be shifted by, for example, 90 degrees (+90 degrees or −90 degrees, depending on implementation). This method of phase shifting in the LO path offers several advantages over phase shifting in the signal path such as providing an accurate phase shift over a wide signal bandwidth, avoiding loopback routing between H-pol and V-pol circuitry to allow better isolation, low insertion loss in the loopback path from Tx-Rx in H-pol and in V-pol, significantly reduced circuit area and compact layout due to the relaxation of Tx-Rx isolation needed and the implementation of a phase shifter with simple switches instead of using bulky inductors and capacitors. In an exemplary embodiment, the phase shifters 320 and 370 may shift the phase of the LO signals in conjunction with the operation of the switches 307, 308, 309, 357, 358 and 359 so that a Tx signal can be provided directly to an input of the LNA 311 and the LNA 361 to perform FDRSB calibration.

In an exemplary embodiment, the switches 307, 308, 309, 357, 358 and 359 may be controlled by the data processor 210 (FIGS. 2A, 2B, 2C) or by another controller.

In an exemplary embodiment, with no LO phase shift applied (Loopback CAL1 mode), a multi-tone continuous wave (MCW) training signal (having both positive and negative frequencies) is created in the digital portion (the data processor 210 of FIGS. 2A, 2B, 2C) and injected into the DACs (over connections 343, 345, 383, 385) to upconvert the signal through the transmit path and subsequently inject into the MCW training signal into the LNA (311, 361) via loopback paths (313, 363) such that the RSB tones don't overlap with the main tones in the same frequency bin. On the positive frequency side, even frequency bins are used for the multi-tones (subcarriers) and on the negative frequency side, odd frequency bins are used. Also, the tone spacings in the MCW training signal are chosen such that the intermodulation products (IM2, IM3, IM5 etc.) don't overlap with the RSB tones.

The main tone total power is measured (denoted as Pmeas1_cal1) per frequency bin, and the RSB or image tone total power is measured (denoted as Pmeas2_cal1) per frequency bin.

Further, while still configured in Loopback CAL1 mode, the frequency location of the multi-tone training signal is shifted by one frequency bin such that the main tone occupies the frequency location of the RSB tones in the prior measurement and the RSB tones occupy frequency location of main tones in the prior measurement. By doing so, the main tones (sub-carriers) occupy odd frequency bins for positive frequencies and even frequency bins for negative frequencies. The main tone total power is measured (denoted as Pmeas3_cal1) per frequency bin.

In an exemplary embodiment, with a 90 degree LO phase shift applied (Loopback CAL2 mode), a multi-tone training signal (having both positive and negative frequencies) is created in the transmit baseband circuitry, upconverted and injected into the LNA (311, 361) via loopback paths (313, 363) as described above such that the RSB tones don't overlap with the main tones in the same frequency bin. The main tone total power is measured (Pmeas1_cal2) per frequency bin, and the RSB or image tone total power is measured (Pmeas2_cal2) per frequency bin.

Further, while still configured in Loopback CAL2 mode, the frequency location of the multi-tone training signal is shifted by one frequency bin such that the main tone occupies the frequency location of the RSB tones in the prior measurement and the RSB tones occupy the frequency location of the main tones in the prior measurement, as described above. The main tone total power is measured (Pmeas3_cal2) per frequency bin.

From the complex measurements taken above, (Pmeas1_cal1, Pmeas2_cal1, Pmeas3_cal1, Pmeas1_cal2, Pmeas2_cal2, Pmeas3_cal2), the following two equations having two unknowns, Tx RSB (β_{TX}) and Rx RSB (β_{RX}) estimates, can be formulated:

$${P}_{meas 2\_ cal 1} = {P}_{meas 3\_ cal 1} \cdot {β}_{TX} + conjugate ( {P}_{meas {1}_{cal 1}} ) \cdot {β}_{R X} \qquad Equation 1$$

$${P}_{meas 2\_ cal 2} = {P}_{meas 3\_ cal 2} \cdot {β}_{TX} + conjugate ( {P}_{meas {1}_{cal 2}} ) \cdot {β}_{R X} \qquad Equation 2$$

Solving these two equations provides the Tx_RSB estimate (β_{TX}) and the Rx_RSB (β_{RX}) simultaneously. Based on the Tx_RSB estimate (β_{TX}), a pre-distortion compensation is done via a complex (or real) FIR filter in the transmit digital basedband such that the multi-tone training signal has greatly attenuated image at the transmitter output. Similarly, a post-distortion compensation is done via a complex (or real) FIR filter in the receive digital baseband such that the image tone (FDRSB) at receive is greatly attenuated. The suppression of the image tones depends on the order (number of filter taps) of the FIR filter as well as the accuracy of the Tx RSB/Rx RSB estimates.

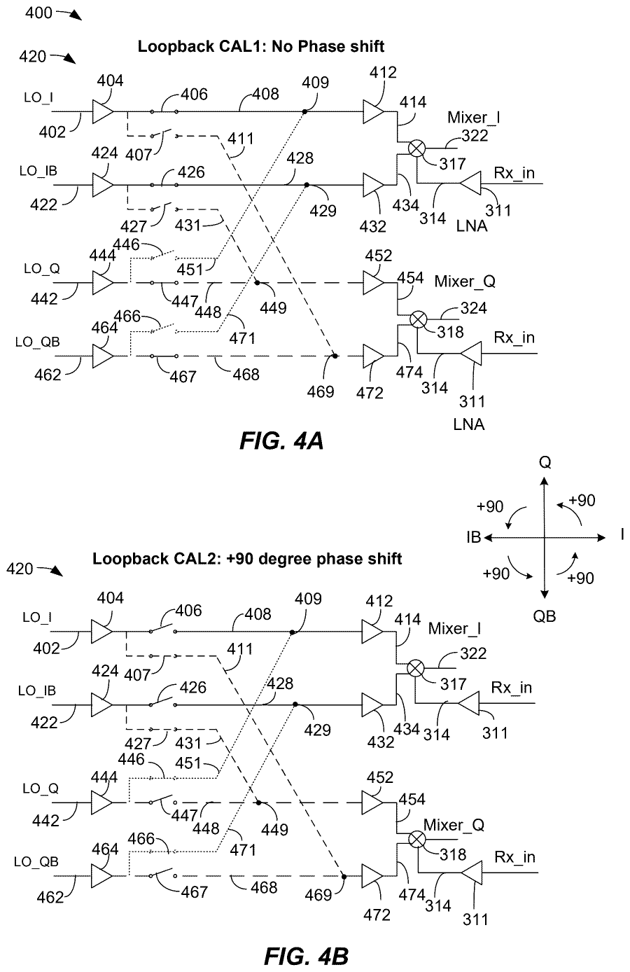

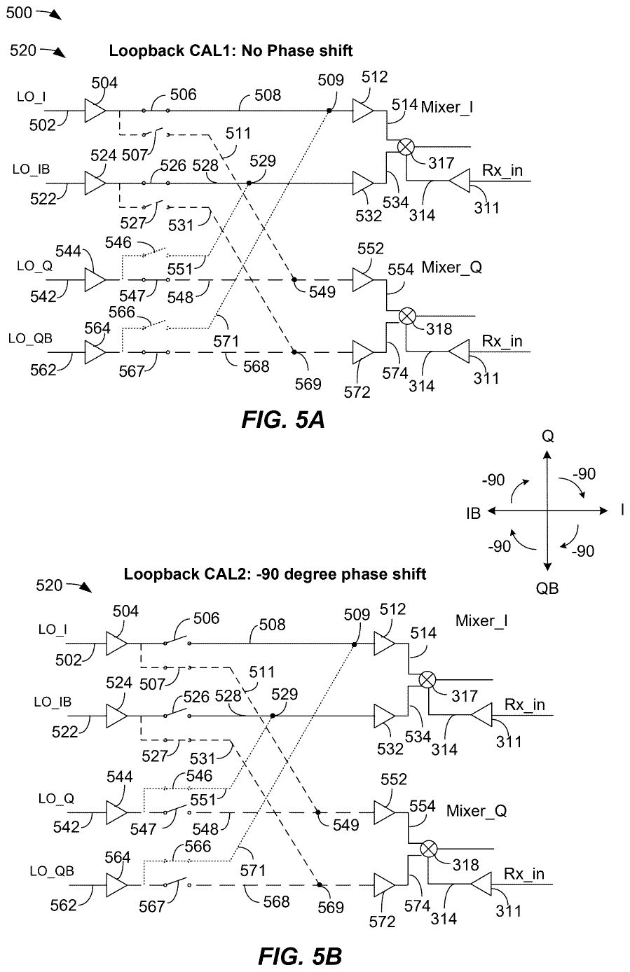

FIGS. 4A and 4B are a diagram 400 of an exemplary embodiment of a phase shifter of FIG. 3. FIG. 4A shows a phase shifter 420 configured for loopback calibration mode (CAL1) with no LO phase shift and FIG. 4B shows the phase shifter 420 configured in a loopback calibration mode (CAL2) with +90 degree LO phase shift. During the receive (Rx) mode, the phase shifter is configured back to no phase shift with the loopback switches 309 and 359 (FIG. 3) turned off while the input switches 307 and 358 are turned ON. The phase shifter 420 may be an example of the phase shifter 320 or the phase shifter 370 of FIG. 3. In an exemplary embodiment, the phase shifter 420 may include a buffer 404, a switch 406, a switch 407, a node 409, and a buffer 412. The phase shifter 420 may also include a buffer 424, a switch 426, a switch 427, a node 429, and a buffer 432. In an exemplary embodiment, the phase shifter 420 may receive an LO_I (I+) signal on connection 402 at an input of the buffer 404, and may receive an LO_IB (I−) signal on connection 422 at an input of the buffer 424. The LO_I (I+) signal and the LO_IB (I−) signal may be provided by the PLL 347 over connection 351 (FIG. 3). Certain connections in FIGS. 4A and 4B, and in FIGS. 5A and 5B (described below), are illustrated with different line types (e.g., solid versus dashed lines, different styles of dashed line, etc.). These different line types are used to aid the reader in being able to visually distinguish the different connections in the figures, and are not indicative of a functional difference between the elements.

In an exemplary embodiment, the phase shifter 420 may include a buffer 444, a switch 446, a switch 447, a node 449, and a buffer 452. The phase shifter 420 may also include a buffer 464, a switch 466, a switch 467, a node 469, and a buffer 472. In an exemplary embodiment, the phase shifter 420 may receive an LO_Q (Q+) signal on connection 442 at an input of the buffer 444, and may receive an LO_QB (Q−) signal on connection 462 at an input of the buffer 464. The LO_Q (Q+) signal and the LO_QB (Q−) signal may be provided by the PLL 347 over connection 351 (FIG. 3). The buffers 412, 432, 452, 472 are described above as being included in the phase shifter 420. Buffer 412 and/or 432, however, may be implemented in the mixer 317, and/or buffer 452 and/or 472 may be implemented in the mixer 318. Regardless of whether the buffer is implemented in the phase shifter 420 or the respective mixer, each of these buffers may be considered to be a buffer of its respective mixer.

In an exemplary embodiment, the output of the buffer 412 is provided over connection 414 to the I mixer 317, and the output of the buffer 432 is provided over connection 434 to the I mixer 317 (FIG. 3). In an exemplary embodiment, the output of the buffer 452 is provided over connection 454 to the Q mixer 318, and the output of the buffer 472 is provided over connection 474 to the Q mixer 318 (FIG. 3).

As described in FIG. 3, the I mixer 317 is configured to receive the output of the LNA 311 over connection 314 and provide a downconverted signal over connection 322. Similarly, as described in FIG. 3, the Q mixer 318 is configured to receive the output of the LNA 311 over connection 314 and provide a downconverted signal over connection 324.

In an exemplary embodiment in receive mode or loopback calibration (CAL1) mode, the switch 406 is conductive and the LO_I (I+) signal is provided from the buffer 404 to the buffer 412 over connection 408 such that the LO_I signal appears on connection 414.

Similarly, in receive mode or loopback calibration (CAL1) mode, the switch 426 is conductive and the LO_IB (I−) signal is provided from the buffer 424 to the buffer 432 over connection 428 such that the LO_IB (I−) signal appears on connection 434.

Similarly, in receive mode, or loopback calibration (CAL1) mode, the switch 447 is conductive and the LO_Q (Q+) signal is provided from the buffer 444 to the buffer 452 over connection 448 such that the LO_Q signal appears on connection 454.

In an exemplary embodiment in receive mode or loopback calibration (CAL1) mode, the switch 467 is conductive and the LO_QB (Q−) signal is provided from the buffer 464 to the buffer 472 over connection 468 such that the LO_QB (Q−) signal appears on connection 474.

However, when in loopback calibration (CAL2) mode, in an exemplary embodiment, the switch 406 is non-conductive, the switch 407 is conductive, and the LO_I (I+) signal is provided from the buffer 404 to the buffer 472 over connection 411 such that the LO_I signal appears on connection 474, showing a +90 degree phase shift for the QB signal.

Similarly, in an exemplary embodiment of loopback calibration (CAL2) mode, the switch 426 is non-conductive, the switch 427 is conductive, and the LO_IB (I−) signal is provided from the buffer 424 to the buffer 452 over connection 431 such that the LO_IB signal appears on connection 454, showing a +90 degree phase shift for the Q signal.

Similarly, in an exemplary embodiment of loopback calibration (CAL2) mode, the switch 447 is non-conductive, the switch 446 is conductive, and the LO_Q (Q+) signal is provided from the buffer 444 to the buffer 412 over connection 451 such that the LO_Q signal appears on connection 414, showing a +90 degree phase shift for the I signal.

Similarly, in an exemplary embodiment of loopback calibration (CAL2) mode, the switch 467 is non-conductive, the switch 466 is conductive, and the LO_QB (Q−) signal is provided from the buffer 464 to the buffer 432 over connection 471 such that the LO_QB signal appears on connection 434, showing a +90 degree phase shift for the IB signal. In this way, phases (e.g., I, IB, Q and QB) of the LO signals (from the PLL 347) may be exchanged by the phase shifter 420, for example in response to a calibration mode (e.g., CAL2).

In accordance with an exemplary embodiment, to perform FDRSB, initially a multi-tone continuous wave (MCW) tone training signal (having positive and negative frequencies) is injected from a transmitter into a receiver in loopback (CAL1) mode (no LO phase shift). For example, the DA 312 can use the loopback path 313 enabled when the switches 308 and 308 are non-conductive and switch 309 is conductive, to inject the Tx signal from the output of the DA 312 into the input of the LNA 311. The MCW tone training signal is chosen such that the image tones and the nonlinear products (IM2, IM3, IM4, IM5) do not overlap with the main tones. The main tones and the image tones are measured.

Next, the transceiver is configured for loopback calibration (CAL2) mode such that the LO signal is shifted in phase by, for example, +90 degrees as described in FIGS. 4A and 4B.

Next, a multi-tone continuous wave (MCW) tone training signal (having positive and negative frequencies) is again injected from the transmitter into the receiver. For example, the DA 312 can use the loopback path 313 enabled when the switch 309 is conductive, to inject the Tx signal from the DA 312 into the input of the LNA 311. The main tones and the image tones are again measured this time with the +90 degree LO phase shift.

Next, the ratio of the image tone to the main tone power both without the LO phase shift and with the +90 degree LO phase shift is measured. In this manner, both Tx RSB and Rx RSB can be jointly estimated using the known LO phase shift (+90 degrees in this example).

Once the estimation is performed, a multi-tap complex (or real) finite impulse response (FIR) filter (cFIR) is configured with coefficients to compensate the Tx FDRSB by applying predistortion to the Tx signal and then Rx FDRSB compensation is done by the post-distortion of the received signal.

FIGS. 5A and 5B are a diagram 500 of an alternative exemplary embodiment of a phase shifter of FIG. 3. FIG. 5A shows a phase shifter 520 configured for a loopback calibration (CAL1) mode with no phase shift and FIG. 5B shows the phase shifter 520 configured in a loopback calibration CAL2 mode. However, in loopback (CAL2) mode the phase shifter 520 is configured to impart a −90 degree phase shift to the LO signals instead of a +90 degree phase shift as shown in FIGS. 4A and 4B. While one loopback or calibration mode (e.g., CAL2) having either a +90 degree phase shift to the LO signals or a −90 degree phase shift to the LO signals is described, in some examples both a +90 degree phase shift to the LO signals and a −90 degree phase shift to the LO signals are supported (e.g., both a CAL2 and CAL3 loopback mode, respectively). These loopback modes may be supported by respective phase shifters (e.g., the phase shifters 420, 520), or a single phase shifter may be configured to implement both a +90 degree phase shift to the LO signals and a −90 degree phase shift to the LO signals, for example by combining the switches and connections illustrated and described with respect to FIGS. 4A-5B. For example, in the embodiment illustrated in FIG. 4A, the buffer 404 may additionally be connected to switch 507 and connection 511 such that the LO_I signal can be selectively provided to the buffer 552, etc.

In the example illustrated in FIGS. 5A and 5B, during the receive (Rx) mode, the phase shifter is configured back to no phase shift with the loopback switches 309 and 359 turned off while the input switches 307 and 358 are turned ON. The phase shifter 520 may be an example of the phase shifter 320 or 370 of FIG. 3. In an exemplary embodiment, the phase shifter 520 may include a buffer 504, a switch 506, a switch 507, a node 509, and a buffer 512. The phase shifter 520 may also include a buffer 524, a switch 526, a switch 527, a node 529, and a buffer 532. In an exemplary embodiment, the phase shifter 520 may receive an LO_I (I+) signal on connection 502 at an input of the buffer 504, and may receive an LO_IB (I−) signal on connection 522 at an input of the buffer 524. The LO_I (I+) signal and the LO_IB (I−) signal may be provided by the PLL 347 over connection 351 (FIG. 3).

In an exemplary embodiment, the phase shifter 520 may include a buffer 544, a switch 546, a switch 547, a node 549, and a buffer 552. The phase shifter 520 may also include a buffer 564, a switch 566, a switch 567, a node 569, and a buffer 572. In an exemplary embodiment, the phase shifter 520 may receive an LO_Q (Q+) signal on connection 542 at an input of the buffer 544, and may receive an LO_QB (Q−) signal on connection 562 at an input of the buffer 564. The LO_Q (Q+) signal and the LO_QB (Q−) signal may be provided by the PLL 347 over connection 351 (FIG. 3). The buffers 512, 532, 552, 572 are described above as being included in the phase shifter 520. Buffer 512 and/or 532, however, may be implemented in the mixer 317, and/or buffer 552 and/or 572 may be implemented in the mixer 318. Regardless of whether the buffer is implemented in the phase shifter 520 or the respective mixer, each of these buffers may be considered to be a buffer of its respective mixer.

In an exemplary embodiment, the output of the buffer 512 is provided over connection 514 to the I mixer 317, and the output of the buffer 532 is provided over connection 534 to the I mixer 317 (FIG. 3). In an exemplary embodiment, the output of the buffer 552 is provided over connection 554 to the Q mixer 318, and the output of the buffer 572 is provided over connection 574 to the Q mixer 318 (FIG. 3).

As described in FIG. 3, the I mixer 317 is configured to receive the output of the LNA 311 over connection 314 and provide a downconverted signal over connection 322. Similarly, as described in FIG. 3, the Q mixer 318 is configured to receive the output of the LNA 311 over connection 314 and provide a downconverted signal over connection 324.

In an exemplary embodiment in receive mode or loopback calibration (CAL1) mode, the switch 506 is conductive and the LO_I (I+) signal is provided from the buffer 504 to the buffer 512 over connection 508 such that the LO_I signal appears on connection 514.

Similarly, in receive mode or loopback calibration (CAL1) mode, the switch 526 is conductive and the LO_IB (I−) signal is provided from the buffer 524 to the buffer 532 over connection 528 such that the LO_IB (I−) signal appears on connection 534.

Similarly, in receive mode or loopback calibration (CAL1) mode, the switch 547 is conductive and the LO_Q (Q+) signal is provided from the buffer 544 to the buffer 552 over connection 548 such that the LO_Q signal appears on connection 554.

In an exemplary embodiment in receive mode or loopback calibration (CAL1) mode, the switch 567 is conductive and the LO_QB (Q−) signal is provided from the buffer 564 to the buffer 572 over connection 568 such that the LO_QB (Q−) signal appears on connection 474.

However, when in loopback calibration (CAL2) mode, in an exemplary embodiment, the switch 506 is non-conductive, the switch 507 is conductive, and the LO_I (I+) signal is provided from the buffer 504 to the buffer 552 over connection 511 such that the LO_I signal appears on connection 554, showing a −90 degree phase shift for the Q signal.

Similarly, in an exemplary embodiment of loopback calibration (CAL2) mode, the switch 526 is non-conductive, the switch 527 is conductive, and the LO_IB (I−) signal is provided from the buffer 524 to the buffer 572 over connection 531 such that the LO_IB signal appears on connection 574, showing a −90 degree phase shift for the QB signal.

Similarly, in an exemplary embodiment of loopback calibration (CAL2) mode, the switch 547 is non-conductive, the switch 546 is conductive, and the LO_Q (Q+) signal is provided from the buffer 544 to the buffer 532 over connection 551 such that the LO_Q signal appears on connection 534, showing a −90 degree phase shift for the IB signal.

Similarly, in an exemplary embodiment of loopback calibration (CAL2) mode, the switch 567 is non-conductive, the switch 566 is conductive, and the LO_QB (Q−) signal is provided from the buffer 564 to the buffer 512 over connection 571 such that the LO_QB signal appears on connection 514, showing a −90 degree phase shift for the I signal. In this way, phases (e.g., I, IB, Q and QB) of the LO signals (from the PLL 347) may be exchanged by the phase shifter 520, for example in response to a calibration mode (e.g., CAL2 or CAL3).

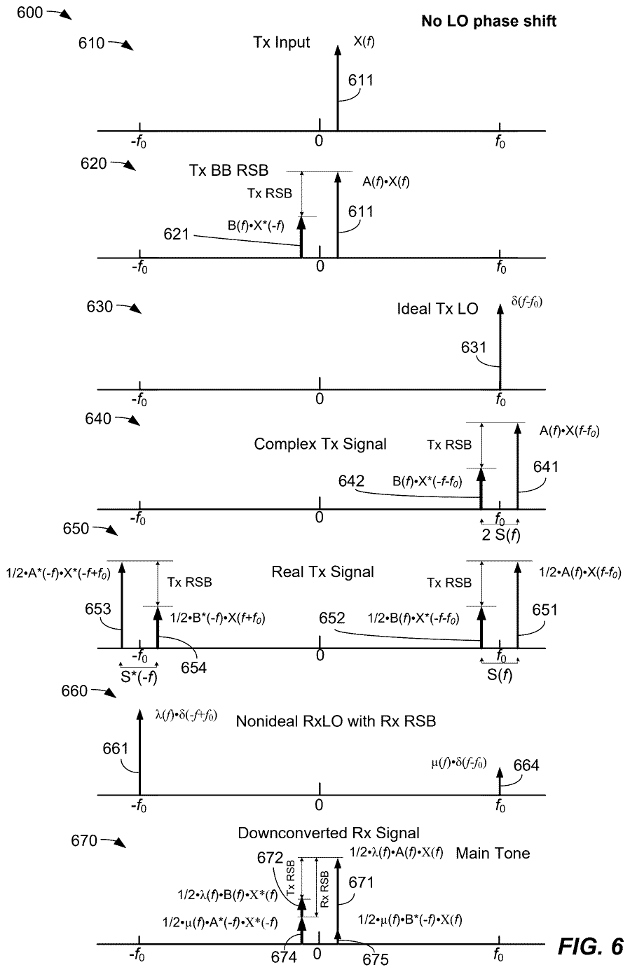

FIG. 6 is a series of graphs 600 showing a representative Tx and Rx RSB measurement with no LO phase shift (Loopback CAL1 mode) for an MCW training signal for illustration purposes. During the calibration, a multi-tone continuous wave (MCW) training tone with positive and negative frequencies is injected into the LNA (311, 361). The graph 610 has a horizontal axis showing frequency. The signal 611 represents a main training Tx signal (positive frequency only) input to the LNA 311 for example using the loop back path 313.

The graph 620 shows the main training Tx signal 611 and a Tx baseband (BB) RSB signal 621. The Tx BB signal (main Tx signal 611 and Tx BB RSB signal 621) can be written as Y_{TXBB}(f)=A(f)·X(f)+B(f)·X*(−f) and Tx RSB is defined as

$${β}_{t} ( f ) = \frac{B ( f )}{A ( f )}$$

The graph 630 shows an ideal Tx LO signal 631.

The graph 640 shows a complex Tx signal having portion 641 showing the main signal and a portion 642 representing Tx RSB around the frequency, f₀.

The graph 650 shows a real Tx signal having portion 651 showing the main signal and a portion 652 representing Tx RSB around the frequency, f₀ and shows a real Tx signal having portion 653 showing the main signal and a portion 654 representing Tx RSB around the frequency-f₀. Note that the portion 642 representing Tx RSB 642 is shown to be caused only due to BB RSB for illustration purposes. In reality, a nonideal Tx LO signal will also contribute to negative frequency components, which are not shown in the graph 640, and which will contribute to Tx RSB in the real signal.

The graph 660 shows a non-ideal Rx LO signal with Rx RSB, where the signal 661 represents the LO signal at a frequency of −f₀ and the signal 664 represents the Rx RSB at a frequency of f₀. The Rx RSB signal 664 can be defined as

$${β}_{r} ( f ) = \frac{μ ( f )}{{λ}^{*} ( f )} .$$

The graph 670 shows a downconverted Rx signal, where the signal 671 represents the main Rx tone, the signal 672 represents the Tx RSB, the signal 674 represents the Rx RSB and the signal 675 represents an image tone of the Tx RSB 672 overlapping with the main Rx tone 671 and is often negligible and can be ignored. In this example, Rx RSB 674 is shown to be only due to RxLO for illustration purposes, however it can be due to RxLO as well as Rx BB.

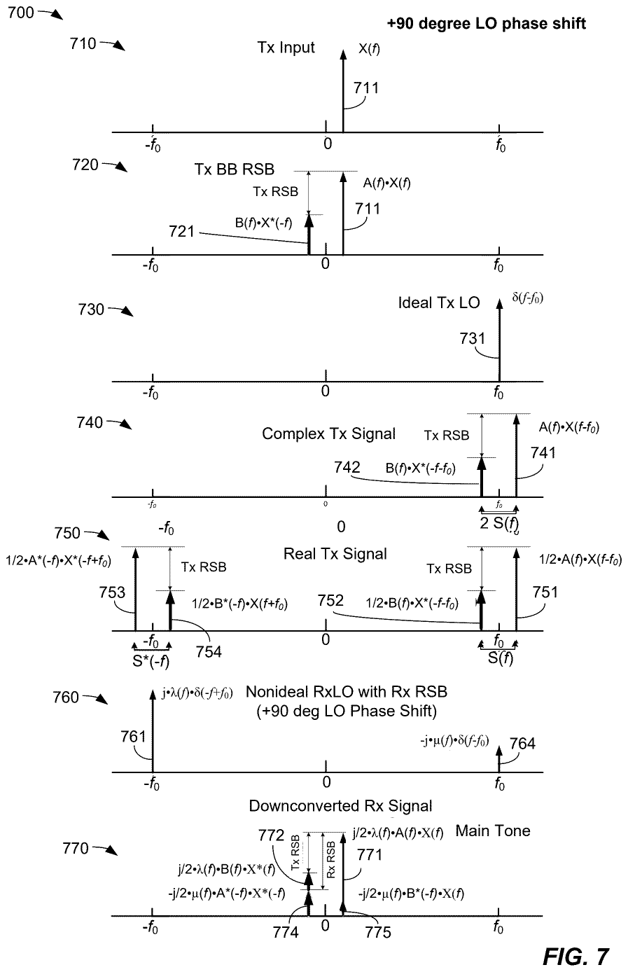

FIG. 7 is a series of graphs 700 showing Tx and Rx RSB measurement with a +90 degree LO phase shift. The graph 710 has a horizontal axis showing frequency. The signal 711 represents a main Tx training signal input to the LNA 311 for example using the loop back path 313.

The graph 720 shows the main Tx training signal 711 and a signal 721 representing Tx RSB.

The graph 730 shows an ideal Tx LO signal 731.

The graph 740 shows a complex Tx signal having portion 741 showing the main signal and a portion 742 representing Tx RSB around the frequency, f₀.

The graph 750 shows a real Tx signal having portion 751 showing the main signal and a portion 752 representing Tx RSB around the frequency, f₀ and shows a real Tx signal having portion 753 showing the main signal and a portion 754 representing Tx RSB around the frequency −f₀.

The graph 760 shows a non-ideal Rx LO signal with Rx RSB and a +90 degree phase shift, where the signal 761 represents the LO signal at a frequency of −f₀ and the signal 764 represents the Rx RSB at a frequency of f₀.

The graph 770 shows a downconverted Rx signal, where the signal 771 represents the main Rx tone, the signal 772 represents the Tx RSB, the signal 774 represents the Rx RSB and the signal 775 represents an image tone of the Tx RSB tone 772, overlapping with the main Rx tone 771.

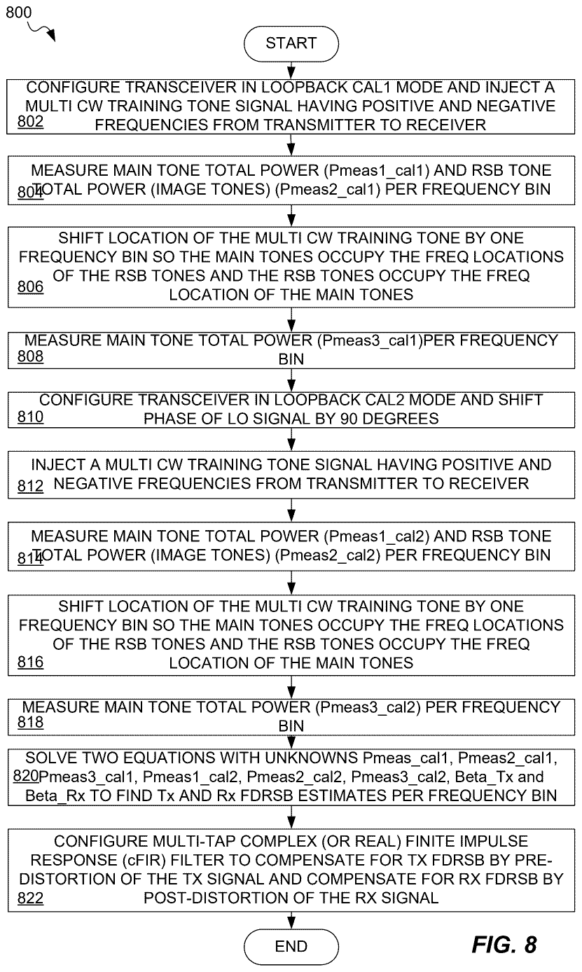

FIG. 8 is a flow chart 800 describing an example of the operation of a method for joint Tx and Rx FDRSB calibration. The blocks in the method 800 can be performed in or out of the order shown, and in some embodiments, can be performed at least in part in parallel.

In block 802, to perform FDRSB, initially the transceiver is configured in loopback CAL1 mode with no LO phase shift (as described in FIGS. 4A) and a multi-tone continuous wave (MCW) tone training signal (having positive and negative frequencies) is injected from a transmitter into a receiver. For example, the DA 312 can use the loopback path 313 enabled when the switch 309 is conductive, to inject the Tx signal into the input of the LNA 311. The MCW tone training signal is such that the image tones and the nonlinear intermodulation tones (such as IM2/IM3/IM4/IM5 etc.) do not overlap with the main tones. On the positive frequency side, even frequency bins are used for the multi-tones (subcarriers) and on the negative frequency side, odd frequency bins are used.

In block 804, the main tone total power is measured (Pmeas1_cal1) per frequency bin, and the RSB tone total power is measured (Pmeas2_cal1) per frequency bin. For example, the error estimation and compensation element 340 measures the main tone total power (Pmeas1_cal1), and the RSB tone total power (Pmeas2_cal1).

In block 806, the location of the multi-tone training signal is shifted by one frequency bin such that the main tone occupies the frequency location of the RSB tones in the prior measurement and the RSB tones occupy frequency location of main tones in the prior measurement. By doing so, the main tones (sub-carriers) occupy odd frequency bins for positive frequencies and even frequency bins for negative frequencies.

In block 808, the main tone total power is measured (Pmeas3_cal1) per frequency bin. For example, the error estimation and compensation element 340 measures the main tone total power (Pmeas3_cal1).

In block 810, the transceiver is configured for loopback calibration (CAL2) mode such that the LO signal is shifted in phase by, for example, 90 degrees. For example, the phase shifter 420 can be enabled to shift the phase of the LO signal by +90 degrees as described in FIGS. 4A and 4B.

In block 812, a multi-tone (MCW) tone training signal (having positive and negative frequencies) is again injected from the transmitter into the receiver. For example, the DA 312 can use the loopback path 313 enabled when the switch 309 is conductive, to inject the Tx signal into the input of the LNA 311.

The MCW tone training signal is such that the image tones and the nonlinear intermodulation tones (such as IM2/IM3/IM4/IM5 etc.) do not overlap with the main tones. On the positive frequency side, even frequency bins are used for the multi-tones (subcarriers) and on the negative frequency side, odd frequency bins are used.

In block 814, the main tone total power is measured (Pmeas1_cal2) per frequency bin, and the RSB tone total power is measured (Pmeas2_cal2) per frequency bin. For example, the error estimation and compensation element 340 measures the main tone total power (Pmeas1_cal2), and the RSB tone total power (Pmeas2_cal2).

In block 816, the location of the multi-tone training signal is shifted by one frequency bin such that the main tone occupies the frequency location of the RSB tones in the prior measurement and the RSB tones occupy frequency location of main tones in the prior measurement. By doing so, the main tones (sub-carriers) occupy odd frequency bins for positive frequencies and even frequency bins for negative frequencies.

In block 818, the main tone total power is measured (Pmeas3_cal2) per frequency bin. For example, the error estimation and compensation element 340 measures the main tone total power (Pmeas3_cal2).

In block 820, two equations with unknowns Pmeas_cal1, Pmeas2_cal1, Pmeas3_cal1, Pmeas1_cal2, Pmeas2_cal2, Pmeas3_cal2, Beta_Tx and Beta_Rx are simultaneously solved with matrix computation to find the Tx and Rx FDRSB estimates for each frequency bin. For example, the error estimation and compensation element 340 simultaneously solves the two equations with unknowns Pmeas_cal1, Pmeas2_cal1, Pmeas3_cal1, Pmeas1_cal2, Pmeas2_cal2, Pmeas3_cal2, Beta_Tx and Beta_Rx to find the Tx and Rx FDRSB estimates.

In this manner, both Tx RSB and Rx RSB can be jointly estimated using the known LO phase shift (90 degrees in this example).

In block 822, a complex (or real) multi-tap complex finite impulse response (cFIR) filter (cFIR) is configured with coefficients to compensate the Tx FDRSB by applying predistortion to the Tx signal and then Rx FDRSB compensation is done by the post-distortion of the received signal. For example, a cFIR filter in the error estimation and compensation element 340 may be configured to compensate for the Tx FDRSB and the Rx FDRSB.

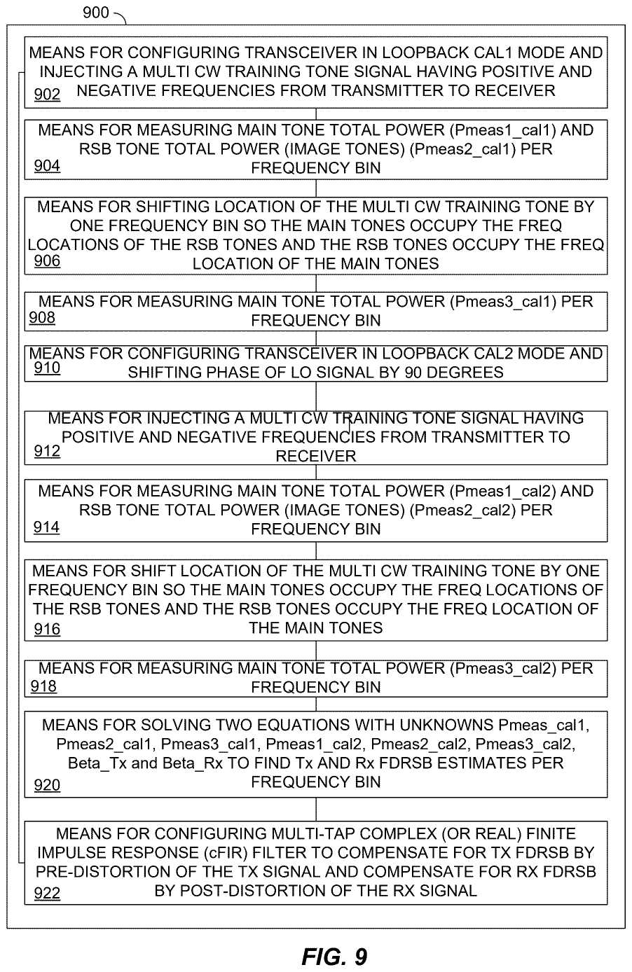

FIG. 9 is a functional block diagram of an apparatus 900 for joint Tx and Rx FDRSB calibration. The apparatus 900 comprises means 902 for configuring a transceiver in loopback CAL1 mode with no LO phase shift and injecting a multi-tone continuous wave (MCW) tone training signal (having positive and negative frequencies) from a transmitter into a receiver. In certain embodiments, the means 902 for configuring a transceiver in loopback CAL1 mode with no LO phase shift and injecting a multi-tone continuous wave (MCW) tone training signal (having positive and negative frequencies) from a transmitter into a receiver can be configured to perform one or more of the functions described in operation block 802 of method 800 (FIG. 8). In an exemplary embodiment, the means 902 for configuring a transceiver in loopback CAL1 mode with no LO phase shift and injecting a multi-tone continuous wave (MCW) tone training signal (having positive and negative frequencies) from a transmitter into a receiver may comprise the DA 312 using the loopback path 313 enabled when the switch 309 is conductive, to inject the Tx signal into the input of the LNA 311.

The apparatus 900 also comprises means 904 for measuring the main tone total power (Pmeas1_cal1) per frequency bin, and the RSB tone total power (Pmeas2_cal1) per frequency bin. In certain embodiments, the means 904 for measuring the main tone total power (Pmeas1_cal1) per frequency bin, and the RSB tone total power (Pmeas2_cal1) per frequency bin can be configured to perform one or more of the functions described in operation block 804 of method 800 (FIG. 8). In an exemplary embodiment, the means 904 for measuring the main tone total power (Pmeas1_cal1) per frequency bin, and the RSB tone total power (Pmeas2_cal1) per frequency bin may comprise the error estimation and compensation element 340 measuring the main tone total power (Pmeas1_cal1) per frequency bin, and the RSB tone total power (Pmeas2_cal1) per frequency bin.

The apparatus 900 also comprises means 906 for shifting the location of the multi-tone training signal by one frequency bin. In certain embodiments, the means 906 for shifting the location of the multi-tone training signal by one frequency bin can be configured to perform one or more of the functions described in operation block 806 of method 800 (FIG. 8). In an exemplary embodiment, the means 906 for shifting the location of the multi-tone training signal by one frequency bin may comprise shifting the location of the multi-tone training signal by one frequency bin such that the main tone occupies the frequency location of the RSB tones in the prior measurement and the RSB tones occupy frequency location of main tones in the prior measurement.

The apparatus 900 also comprises means 908 for measuring the main tone total power (Pmeas3_cal1) per frequency bin. In certain embodiments, the means 908 for measuring the main tone total power (Pmeas3_cal1) per frequency bin can be configured to perform one or more of the functions described in operation block 808 of method 800 (FIG. 8). In an exemplary embodiment, the means 908 for measuring the main tone total power (Pmeas3_cal1) per frequency bin may comprise the error estimation and compensation element 340 measuring the main tone total power (Pmeas3_cal1) per frequency bin.

The apparatus 900 also comprises means 910 for configuring the transceiver for loopback calibration (CAL2) mode such that the LO signal is shifted in phase by, for example, 90 degrees. In certain embodiments, the means 910 for configuring the transceiver for loopback calibration (CAL2) mode such that the LO signal is shifted in phase by, for example, 90 degrees can be configured to perform one or more of the functions described in operation block 810 of method 800 (FIG. 8). In an exemplary embodiment, the means 910 for configuring the transceiver for loopback calibration (CAL2) mode such that the LO signal is shifted in phase by, for example, 90 degrees may comprise the phase shifter 420 being enabled to shift the phase of the LO signal by +90 degrees.

The apparatus 900 also comprises means 912 for injecting a multi-tone (MCW) tone training signal (having positive and negative frequencies) from the transmitter into the receiver. In certain embodiments, the means 912 for injecting a multi-tone (MCW) tone training signal (having positive and negative frequencies) from the transmitter into the receiver can be configured to perform one or more of the functions described in operation block 812 of method 800 (FIG. 8). In an exemplary embodiment, the means 912 for injecting a multi-tone (MCW) tone training signal (having positive and negative frequencies) from the transmitter into the receiver may comprise the DA 312 using the loopback path 313 when the switch 309 is conductive, to inject the Tx signal into the input of the LNA 311.

The apparatus 900 also comprises means 914 for measuring the main tone total power (Pmeas1_cal2) per frequency bin, and the RSB tone total power (Pmeas2_cal2) per frequency bin. In certain embodiments, the means 914 for measuring the main tone total power (Pmeas1_cal2) per frequency bin, and the RSB tone total power (Pmeas2_cal2) per frequency bin can be configured to perform one or more of the functions described in operation block 814 of method 800 (FIG. 8). In an exemplary embodiment, the means 914 for measuring the main tone total power (Pmeas1_cal2) per frequency bin, and the RSB tone total power (Pmeas2_cal2) per frequency bin may comprise the error estimation and compensation element 340 measuring the main tone total power (Pmeas1_cal2) per frequency bin, and the RSB tone total power (Pmeas2_cal2) per frequency bin.

The apparatus 900 also comprises means 916 for shifting the location of the multi-tone training signal by one frequency bin. In certain embodiments, the means 916 for shifting the location of the multi-tone training signal by one frequency bin can be configured to perform one or more of the functions described in operation block 816 of method 800 (FIG. 8). In an exemplary embodiment, the means 916 for shifting the location of the multi-tone training signal by one frequency bin may comprise shifting the location of the multi-tone training signal by one frequency bin such that the main tone occupies the frequency location of the RSB tones in the prior measurement and the RSB tones occupy frequency location of main tones in the prior measurement.

The apparatus 900 also comprises means 918 for measuring the main tone total power (Pmeas3_cal2) per frequency bin. In certain embodiments, the means 918 for measuring the main tone total power (Pmeas3_cal2) per frequency bin can be configured to perform one or more of the functions described in operation block 818 of method 800 (FIG. 8). In an exemplary embodiment, the means 918 for measuring the main tone total power (Pmeas3_cal2) per frequency bin may comprise the error estimation and compensation element 340 measuring the main tone power (Pmeas3_cal2) per frequency bin.

The apparatus 900 also comprises means 920 for simultaneously solving two equations with unknowns Pmeas_cal1, Pmeas2_cal1, Pmeas3_cal1, Pmeas1_cal2, Pmeas2_cal2, Pmeas3_cal2, Beta_Tx and Beta_Rx to find the Tx and Rx FDRSB estimates per frequency bin via matrix computation. In certain embodiments, the means 920 for simultaneously solving two equations with unknowns Pmeas_cal1, Pmeas2_cal1, Pmeas3_cal1, Pmeas1_cal2, Pmeas2_cal2, Pmeas3_cal2, Beta_Tx and Beta_Rx to find the Tx and Rx FDRSB estimates per frequency bin via matrix computation can be configured to perform one or more of the functions described in operation block 820 of method 800 (FIG. 8). In an exemplary embodiment, the means 920 for simultaneously solving two equations with unknowns Pmeas_cal1, Pmeas2_cal1, Pmeas3_cal1, Pmeas1_cal2, Pmeas2_cal2, Pmeas3_cal2, Beta_Tx and Beta_Rx to find the Tx and Rx FDRSB estimates per frequency bin via matrix computation may comprise the error estimation and compensation element 340 simultaneously solving the two equations with unknowns Pmeas_cal1, Pmeas2_cal1, Pmeas3_cal1, Pmeas1_cal2, Pmeas2_cal2, Pmeas3_cal2, Beta_Tx and Beta_Rx to find the Tx and Rx FDRSB estimates per frequency bin via matrix computation.

The apparatus 900 also comprises means 922 for configuring a complex (or real) multi-tap complex finite impulse response (cFIR) filter (cFIR) with coefficients to compensate the Tx FDRSB by applying predistortion to the Tx signal and then compensating Rx FDRSB by the post-distortion of the received signal. In certain embodiments, the means 922 for configuring a complex (or real) multi-tap complex finite impulse response (cFIR) filter (cFIR) with coefficients to compensate the Tx FDRSB by applying predistortion to the Tx signal and then compensating Rx FDRSB by the post-distortion of the received signal can be configured to perform one or more of the functions described in operation block 822 of method 800 (FIG. 8). In an exemplary embodiment, the means 922 for configuring a complex (or real) multi-tap complex finite impulse response (cFIR) filter (cFIR) with coefficients to compensate the Tx FDRSB by applying predistortion to the Tx signal and then compensating Rx FDRSB by the post-distortion of the received signal may comprise configuring a cFIR (or real FIR) filter in the error estimation and compensation element 340 to compensate for the Tx FDRSB and the Rx FDRSB.

Implementation examples are described in the following numbered clauses:

1. A residual sideband (RSB) calibration system, comprising: a phase locked loop (PLL) circuit shared between a transmit (Tx) circuit and a receive (Rx) circuit, the PLL circuit configured to provide a local oscillator (LO) signal to transmit mixers in the Tx circuit and to receive mixers in the Rx circuit; a phase shifter connected between an output of the PLL circuit and the receive mixers; and a loopback circuit connecting the Tx circuit and the Rx circuit.

2. The RSB calibration system of clause 1, wherein the LO signal comprises a plurality of LO phases and the phase shifter exchanges the LO phases responsive to a calibration mode.

3. The RSB calibration system of any of clauses 1 through 2, wherein the phase shifter is configured to shift the LO signal of the PLL circuit by +90 degrees.

4. The RSB calibration system of any of clauses 1 through 2, wherein the phase shifter is configured to shift the LO signal of the PLL circuit by −90 degrees.

5. The RSB calibration system of any of clauses 1 through 4, wherein the Tx circuit and the Rx circuit are configured to operate in a time division duplexing (TDD) communication system.

6. The RSB calibration system of clause 3, wherein the LO phase shift results in an I (I+) LO signal being replaced with a Q (Q+) LO signal, the Q (Q+) LO signal being replaced with an IB (I−) LO signal, the IB (I−) LO signal being replaced with a QB (Q−) LO signal, and the QB (Q−) LO signal being replaced with the I (I+) LO signal.

7. The RSB calibration system of clause 4, wherein the LO phase shift results in an I (I+) LO signal being replaced with a QB (Q−) LO signal, the QB (Q−) LO signal being replaced by an IB (I−) LO signal, the IB (I−) LO signal being replaced with a Q (Q+) LO signal, and the Q (Q+) LO signal being replaced by the I (I+) LO signal.

8. The RSB calibration system of any of clauses 1 through 7, wherein the phase shifter comprises a first input connected to a first phase of the PLL circuit, where the first input is coupled to a first path that connects to a first buffer of a first mixer and to a second path that connects to a second buffer of a second mixer.

9. The RSB calibration system of clause 8, wherein the phase shifter comprises a second input connected to a second phase of the PLL circuit, where the second input is coupled to a third path that connects to a second buffer of the first mixer and to a fourth path that connects to a first buffer of the second mixer; a third input connected to a third phase of the PLL circuit, where the third input is coupled to a fifth path that connects to the first buffer of the second mixer and to a sixth path that connects to the first buffer of the first mixer; and a fourth input connected to a fourth phase of the PLL circuit, where the fourth input is coupled to a seventh path that connects to the second buffer of the second mixer and to an eighth path that connects to the second buffer of the first mixer.

10. The RSB calibration system of any of clauses 1 through 7, wherein the phase shifter comprises a first input connected to a first phase of the PLL circuit, where the first input is coupled to a first path that connects to a first buffer of a first mixer and to a second path that connects to a first buffer of a second mixer.

11. The RSB calibration system of clause 10, wherein the phase shifter comprises: a second input connected to a second phase of the PLL circuit, where the second input is coupled to a third path that connects to a second buffer of the first mixer and to a fourth path that connects to a second buffer of the second mixer; a third input connected to a third phase of the PLL circuit, where the third input is coupled to a fifth path that connects to the first buffer of the second mixer and to a sixth path that connects to the second buffer of the first mixer; and a fourth input connected to a fourth phase of the PLL circuit, where the fourth input is coupled to a seventh path that connects to the second buffer of the second mixer and to an eighth path that connects to the first buffer of the first mixer.

12. The RSB calibration system of any of clauses 1 through 11, wherein the PLL circuit, the Tx circuit, the Rx circuit, the phase shifter and the loopback circuit are configured to operate at an intermediate frequency (IF) in a millimeter wave (mmW) system.

13. A method for joint transmit and receive residual sideband (RSB) calibration, comprising: injecting a transmit (Tx) signal at a first phase of a local oscillator (LO) into a receive (Rx) circuit via a loopback circuit; measuring a main signal tone and an image signal tone at the first LO phase; shifting the first LO phase signal by 90 degrees to a second LO phase; injecting the Tx signal into the Rx circuit via the loopback circuit; measuring a main signal tone and an image signal tone at the second LO phase; determining a ratio of the image signal tone to the main signal tone at the first LO phase and the second LO phase to obtain a Tx RSB and a Rx RSB; adjusting a filter to compensate for the Tx RSB; and compensating for the Rx RSB by pre-distorting an Rx signal.

14. The method of clause 13, wherein the LO signal comprises a plurality of LO phases and the method further comprises switching the LO phases responsive to a calibration mode.

15. The method of any of clauses 13 through 14, wherein: the shifting comprises shifting the first LO phase signal by one of +90 and −90 degrees when the Tx signal is injected into the Rx circuit.

16. The method of clause 15, further comprising replacing an I (I+) LO signal with a Q (Q+) LO signal, replacing the Q (Q+) LO signal with an IB (I−) LO signal, replacing the IB (I−) LO signal with a QB (Q−) LO signal, and replacing the QB (Q−) LO signal with the I (I+) LO signal.

17. The method of clause 15, further comprising replacing an I (I+) LO signal with a QB (Q−) LO signal, replacing the QB (Q−) LO signal with an IB (I−) LO signal, replacing the IB (I−) LO signal with a Q (Q+) LO signal, and replacing the Q (Q+) LO signal with the I (I+) LO signal.

18. A method for joint transmit and receive residual sideband (RSB) calibration, comprising: generating a local oscillator (LO) signal in a phase locked loop (PLL) circuit, the PLL circuit shared between a transmit (Tx) circuit and a receive (Rx) circuit, the PLL circuit configured to provide the local oscillator (LO) signal to transmit mixers in the Tx circuit and to receive mixers in the Rx circuit; connecting a loopback circuit between the Tx circuit and the Rx circuit, the loopback circuit for injecting a transmit (Tx) signal at a first phase into a receive (Rx) circuit and for injecting the transmit (Tx) signal at a second phase into a receive (Rx) circuit; and generating the second phase by shifting the LO signal with a phase shifter between an output of the PLL circuit and the receive mixers.

19. The method of clause 18, further comprising shifting a phase of the LO signal by one of +90 and −90 degrees when the Tx signal is injected into the Rx circuit a second time.

20. The method of any of clauses 18 through 19, further comprising replacing an I (I+) LO signal with a Q (Q+) LO signal, replacing the Q (Q+) LO signal with an IB (I−) LO signal, replacing the IB (I−) LO signal with a QB (Q−) LO signal, and replacing the QB (Q−) LO signal with the I (I+) LO signal.

The circuit architecture described herein described herein may be implemented on one or more ICs, analog ICs, RFICs, mixed-signal ICs, ASICs, printed circuit boards (PCBs), electronic devices, etc. The circuit architecture described herein may also be fabricated with various IC process technologies such as complementary metal oxide semiconductor (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing the circuit described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

Although selected aspects have been illustrated and described in detail, it will be understood that various substitutions and alterations may be made therein without departing from the spirit and scope of the present invention, as defined by the following claims.

What is claimed is:

1. A residual sideband (RSB) calibration system, comprising:
a phase locked loop (PLL) circuit shared between a transmit (Tx) circuit and a receive (Rx) circuit, the PLL circuit configured to provide a local oscillator (LO) signal to transmit mixers in the Tx circuit and to receive mixers in the Rx circuit;
a phase shifter connected between an output of the PLL circuit and the receive mixers; and
a loopback circuit connecting the Tx circuit and the Rx circuit.

2. The RSB calibration system of claim 1, wherein the LO signal comprises a plurality of LO phases and the phase shifter exchanges the LO phases responsive to a calibration mode.

3. The RSB calibration system of claim 1, wherein the phase shifter is configured to shift the LO signal of the PLL circuit by +90 degrees.

4. The RSB calibration system of claim 1, wherein the phase shifter is configured to shift the LO signal of the PLL circuit by −90 degrees.

5. The RSB calibration system of claim 1, wherein the Tx circuit and the Rx circuit are configured to operate in a time division duplexing (TDD) communication system.

6. The RSB calibration system of claim 3, wherein the LO phase shift results in an I (I+) LO signal being replaced with a Q (Q+) LO signal, the Q (Q+) LO signal being replaced with an IB (I−) LO signal, the IB (I−) LO signal being replaced with a QB (Q−) LO signal, and the QB (Q−) LO signal being replaced with the I (I+) LO signal.

7. The RSB calibration system of claim 4, wherein the LO phase shift results in an I (I+) LO signal being replaced with a QB (Q−) LO signal, the QB (Q−) LO signal being replaced by an IB (I−) LO signal, the IB (I−) LO signal being replaced with a Q (Q+) LO signal, and the Q (Q+) LO signal being replaced by the I (I+) LO signal.

8. The RSB calibration system of claim 1, wherein the phase shifter comprises a first input connected to a first phase of the PLL circuit, where the first input is coupled to a first path that connects to a first buffer of a first mixer and to a second path that connects to a second buffer of a second mixer.

9. The RSB calibration system of claim 8, wherein the phase shifter comprises
a second input connected to a second phase of the PLL circuit, where the second input is coupled to a third path that connects to a second buffer of the first mixer and to a fourth path that connects to a first buffer of the second mixer;
a third input connected to a third phase of the PLL circuit, where the third input is coupled to a fifth path that connects to the first buffer of the second mixer and to a sixth path that connects to the first buffer of the first mixer; and
a fourth input connected to a fourth phase of the PLL circuit, where the fourth input is coupled to a seventh path that connects to the second buffer of the second mixer and to an eighth path that connects to the second buffer of the first mixer.

10. The RSB calibration system of claim 1, wherein the phase shifter comprises a first input connected to a first phase of the PLL circuit, where the first input is coupled to a first path that connects to a first buffer of a first mixer and to a second path that connects to a first buffer of a second mixer.

11. The RSB calibration system of claim 10, wherein the phase shifter comprises:
a second input connected to a second phase of the PLL circuit, where the second input is coupled to a third path that connects to a second buffer of the first mixer and to a fourth path that connects to a second buffer of the second mixer;
a third input connected to a third phase of the PLL circuit, where the third input is coupled to a fifth path that connects to the first buffer of the second mixer and to a sixth path that connects to the second buffer of the first mixer; and
a fourth input connected to a fourth phase of the PLL circuit, where the fourth input is coupled to a seventh path that connects to the second buffer of the second mixer and to an eighth path that connects to the first buffer of the first mixer.

12. The RSB calibration system of claim 1, wherein the PLL circuit, the Tx circuit, the Rx circuit, the phase shifter and the loopback circuit are configured to operate at an intermediate frequency (IF) in a millimeter wave (mmW) system.

13. A method for joint transmit and receive residual sideband (RSB) calibration, comprising:
injecting a transmit (Tx) signal at a first phase of a local oscillator (LO) into a receive (Rx) circuit via a loopback circuit;
measuring a main signal tone and an image signal tone at the first LO phase;
shifting the first LO phase signal by 90 degrees to a second LO phase;
injecting the Tx signal into the Rx circuit via the loopback circuit;
measuring a main signal tone and an image signal tone at the second LO phase;
determining a ratio of the image signal tone to the main signal tone at the first LO phase and the second LO phase to obtain a Tx RSB and a Rx RSB;
adjusting a filter to compensate for the Tx RSB; and
compensating for the Rx RSB by pre-distorting an Rx signal.

14. The method of claim 13, wherein the LO signal comprises a plurality of LO phases and the method further comprises switching the LO phases responsive to a calibration mode.

15. The method of claim 13, wherein:
the shifting comprises shifting the first LO phase signal by one of +90 and −90 degrees when the Tx signal is injected into the Rx circuit.

16. The method of claim 15, further comprising replacing an I (I+) LO signal with a Q (Q+) LO signal, replacing the Q (Q+) LO signal with an IB (I−) LO signal, replacing the IB (I−) LO signal with a QB (Q−) LO signal, and replacing the QB (Q−) LO signal with the I (I+) LO signal.

17. The method of claim 15, further comprising replacing an I (I+) LO signal with a QB (Q−) LO signal, replacing the QB (Q−) LO signal with an IB (I−) LO signal, replacing the IB (I−) LO signal with a Q (Q+) LO signal, and replacing the Q (Q+) LO signal with the I (I+) LO signal.

18. A method for joint transmit and receive residual sideband (RSB) calibration, comprising:
generating a local oscillator (LO) signal in a phase locked loop (PLL) circuit, the PLL circuit shared between a transmit (Tx) circuit and a receive (Rx) circuit, the PLL circuit configured to provide the local oscillator (LO) signal to transmit mixers in the Tx circuit and to receive mixers in the Rx circuit;
connecting a loopback circuit between the Tx circuit and the Rx circuit, the loopback circuit for injecting a transmit (Tx) signal at a first phase into a receive (Rx) circuit and for injecting the transmit (Tx) signal at a second phase into a receive (Rx) circuit; and
generating the second phase by shifting the LO signal with a phase shifter between an output of the PLL circuit and the receive mixers.

19. The method of claim 18, further comprising shifting a phase of the LO signal by one of +90 and −90 degrees when the Tx signal is injected into the Rx circuit a second time.

20. The method of claim 18, further comprising replacing an I (I+) LO signal with a Q (Q+) LO signal, replacing the Q (Q+) LO signal with an IB (I−) LO signal, replacing the IB (I−) LO signal with a QB (Q−) LO signal, and replacing the QB (Q−) LO signal with the I (I+) LO signal.
